(19) United States
(12) Patent Application Publication
(10) Pub. No.: US 2020/0138072 A1
(43) Pub. Date: May 7, 2020

(54) POLYMER-BASED ORAL CANNABINOID AND/OR TERPENE FORMULATIONS

(71) Applicant: Molecular Infusions, LLC, Franklin, MA (US)

(72) Inventors: Tuna Yucel, Medford, MA (US); Marvin J. Rudolph, Sharon, MA (US); Stephen E. Zale, Hopkinton, MA (US); Nicholas J. Boylan, Boylston, MA (US); Scott S. Finnance, Providence, RI (US); Wenmin Yuan, Brookline, MA (US); Gregory Fahs, Watertown, MA (US); Oren Levy, Brookline, MA (US)

(21) Appl. No.: 16/672,057

(22) Filed: Nov. 1, 2019

Related U.S. Application Data
(60) Provisional application No. 62/754,178, filed on Nov. 1, 2018.

(51) Int. Cl. A23L 29/00; A23L 2/52; A23L 29/288; A23P 10/30; B82Y 30/00; B82Y 40/00

(52) U.S. Cl. CPC A23L 29/035; A23L 2/52; B82Y 40/00; A23P 10/30; B82Y 30/00; A23L 29/288

(57) ABSTRACT

The invention is directed to a nanoprecipitate comprising a cannabinoid or a terpene, or combination thereof, a process of preparing the nanoprecipitate, and oral formulations comprising the nanoprecipitate, including beverage additives and edibles.

### RELATED APPLICATION

This application claims the benefit of U.S. Provisional Application Ser. No. 62/754,178, filed Nov. 1, 2018. The entire contents of this application are incorporated by reference herein.

### BACKGROUND OF THE INVENTION

Cannabinoids are a class of active compounds derived from the Cannabis sativa, Cannabis indica, or cannabis hybrid plants commonly known as marijuana. The most well-known cannabinoid is the phytocannabinoid tetrahydrocannabinol (THC), the primary psychoactive compound in cannabis. Delta-9-tetrahydrocannabinol (Δ9-THC) and delta-8-tetrahydrocannabinol (Δ8-THC) mimic the actions of anandamide and 2-arachidonoylglycerol neurotransmitters produced naturally in the body. These cannabinoids produce the effects associated with cannabis by binding to the CB1 cannabinoid receptors in the brain. In addition to psychoactive effects, THC is therapeutically useful in decreasing nausea and vomiting in certain patients, such as in patients with chemotherapy-induced nausea and vomiting (CINV) and for AIDS patients. The cannabinoid, cannabidiol (CBD), does not produce the psychoactive effects of THC but has been described as useful for treating anxiety, insomnia, and chronic pain.

Providing oral formulations for cannabinoids to consumers and patients would therefore be useful. Such formulations are known but generally have poor pharmacokinetic profiles, including high inter-person variability and slow onset of action. Among the challenges associated with the development of oral cannabinoid formulations are the low solubility of cannabinoids in water and the bitter flavor profile of many cannabis extracts.

There is a need in the art for oral cannabinoid formulations that display improved pharmacokinetics and that are neutral in flavor impact.

### SUMMARY OF THE INVENTION

The present invention is directed to a nanoprecipitate comprising a cannabinoid or a terpene, or a combination thereof, a process of preparing the nanoprecipitate, formulations comprising the nanoprecipitate, and cannabinoid and/or terpene infused food products comprising the nanoprecipitate, including beverage additives and beverages.

The invention encompasses a nanoprecipitate comprising a cannabinoid encapsulated by a taste-neutral cationic polymer, and further comprising a non-ionic surfactant. The taste-neutral cationic polymer is preferably an aminoalkyl methacrylate copolymer. In certain aspects, at least one cannabinoid is delta-9-tetrahydrocannabinol (Δ9-THC). In additional aspects, at least one cannabinoid is cannabidiol (CBD).

The invention also encompasses a nanoprecipitate comprising a terpene encapsulated by a taste-neutral cationic polymer, and further comprising a non-ionic surfactant. The taste-neutral cationic polymer is preferably an aminoalkyl methacrylate copolymer.

The invention also includes a cannabinoid infused food product comprising a food carrier and a nanoprecipitate suspended in the food carrier, wherein the nanoprecipitate comprises a cannabinoid encapsulated by a taste-neutral cationic polymer, and wherein the nanoprecipitate further comprises a non-ionic surfactant. In certain aspects, the cannabinoid infused food product is a beverage additive or a beverage comprising an aqueous suspension of the nanoprecipitate described herein.

The invention additionally encompasses a terpene infused food product comprising a food carrier and a nanoprecipitate suspended in the food carrier, wherein the nanoprecipitate comprises a terpene encapsulated by a taste-neutral cationic polymer, and wherein the nanoprecipitate further comprises a non-ionic surfactant. In certain aspects, the terpene infused food product is a beverage additive or a beverage comprising an aqueous suspension of the nanoprecipitate described herein.

Also described is a method of preparing a nanoprecipitate comprising a cannabinoid or a terpene, or a combination thereof, the method comprising combining an aqueous phase and an organic phase wherein:
a. the aqueous phase comprises the non-ionic surfactant and water; and
b. the organic phase comprises the cannabinoid, the terpene, or a combination thereof, and the taste-neutral cationic polymer, and an organic solvent, wherein the organic solvent is miscible with water and wherein the taste-neutral cationic polymer is dissolved in the organic solvent;
   wherein the volume of the aqueous phase is greater than that of the organic phase and whereby a colloidal suspension comprising the nanoprecipitate is formed. The organic solvent can be removed to form an aqueous concentrate. In certain aspects, the aqueous concentrate can be diluted to form an aqueous suspension that can be used in the preparation of a formulation, such as a beverage additive, comprising the cannabinoid and/or terpene. The invention also encompasses a nanoprecipitate, or nanoparticle, prepared by the described method.

The invention also encompasses a method of improving the taste profile and/or increasing the palatability of an oral formulation comprising a cannabinoid or a terpene, or a combination thereof, comprising preparing an oral formulation comprising a nanoprecipitate, wherein the nanoprecipitate comprises a cannabinoid encapsulated by a taste-neutral cationic polymer, and further comprising a non-ionic surfactant. The method can further comprise administering the formulation to a subject or a patient. In additional aspects, the oral formulation is aqueous.

The invention additionally includes a method of masking the taste of a cannabinoid or a terpene, or a combination thereof, in an oral formulation, the method comprising preparing an oral formulation comprising a nanoprecipitate, wherein the nanoprecipitate comprises a cannabinoid encapsulated by a taste-neutral cationic polymer, and further comprising a non-ionic surfactant. The method can further comprise administering the formulation to a subject or a patient. In additional aspects, the oral formulation is aqueous.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic summarizing a nanoprecipitation process.

FIG. 2 shows aggregation propensity during nanoprecipitation versus composition of the organic phase (by weight). THC concentration in the organic phase was varied between 0.9 and 5.8 wt %, while THC-distillate: Eudragit mass ratio was kept constant at 1:2.2.

FIGS. 3A and 3B are plots of particle size diameter (z-average, nm) and polydispersity (AU) as a function of cannabinoid concentration of the suspension (pre- and post-dilution) after the rotary evaporation step.

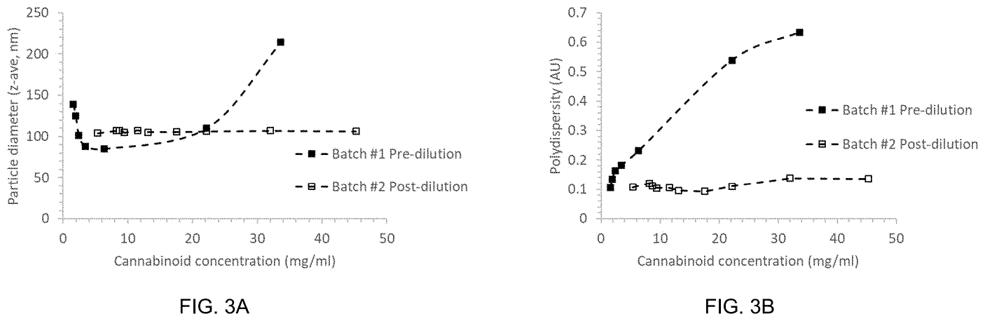

FIG. 4 is a graph of volume (%) as a function of particle diameter (nm) of the THC:E100:P407 nanoparticles at pH 7.7 and pH 4.3.

FIG. 5 is a diagram of lab-scale Concentration, Diafiltration and Concentration (CDC) tangential flow filtration (TFF) tests.

FIG. 6 is a graph showing the time evolution of pressure and concentration factor during CDC TFF test.

FIG. 7 is a graph showing the time evolution of feed flow rate and flux during the CDC TFF test.

### DETAILED DESCRIPTION OF THE INVENTION

A description of preferred embodiments of the invention follows.

As used herein, the words “a” and “an” are meant to include one or more unless otherwise specified. For example, the term “a cannabinoid” encompasses both a single cannabinoid and a combination of two or more cannabinoids such as a mixture of cannabinoids. Similarly, the term “a terpene” encompasses both a single terpene and a combination of two or more terpene, such as a mixture of terpene.

In certain aspects, a cannabinoid or a terpene, or combination thereof, can be present in the formulations and food products in an effective amount. The term “effective amount” means an amount of active ingredient(s) that will result in a desired effect or result and encompasses therapeutically effective amounts. The term “therapeutically effective amount” means an amount of active ingredient(s) that will elicit a desired biological or pharmacological response, e.g., effective to prevent, alleviate, or ameliorate symptoms, treat a disease or disorder (e.g., nausea); or cause a psychoactive effect in the individual.

The term “patient” or “subject” means an animal, including mammals, non-human animals, and especially humans. In one embodiment, the patient or subject is a human. In another embodiment, the patient or subject is a human male. In another embodiment, the patient or subject is a human female. The patient can be a healthy individual or an individual in need of medical treatment. In particular, the terms “patient” and “subject” are intended to include individuals that can medically benefit from the administration of a cannabinoid as well as individuals who can benefit recreationally.

As described above, the present invention includes a nanoprecipitate comprising a cannabinoid or a terpene, or a combination thereof, encapsulated by a taste-neutral cationic polymer, and further comprising a non-ionic surfactant and methods for the preparation thereof. A nanoprecipitate is a nanoparticle or a precipitate synthesized or prepared by nanoprecipitation (also referred to as solvent displacement or interfacial deposition). Methods of nanoprecipitation have been described, for example, in U.S. Pat. No. 5,118,528, the contents of which are expressly incorporated by reference herein. The nanoprecipitate is generally of a size less than 1000 nm. In certain aspects, the nanoprecipitate has a diameter less than about 500 nm.

A taste-neutral cationic polymer can, for example, be a cationic polymer that acts as a taste-masking agent and/or a reverse enteric polymer. Taste-masking agents, including polymers and cationic polymers, are well known in the art. For example, cationic copolymers synthesized from dimethylaminoethyl methacrylate and neutral methacrylic acid are known taste-masking agents. In certain aspects, the taste-neutral cationic polymer is a taste-masking cationic polymer. The terms taste-neutral and flavor-neutral are used interchangeably herein. The taste-neutral cationic polymer can, for example, comprise an amino group and/or can have higher water solubility at an acidic pH than at neutral pH. The cationic polymer can include a dimethylaminoethyl group. In certain aspects, the cationic polymer has the following formula:

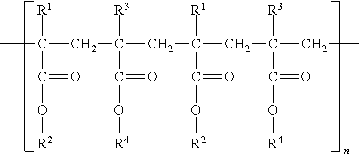

wherein R¹ and R³ are CH₃; R² is CH₂CH₂N(CH₃)₂ and R⁴ is CH₃ or C₄H₉. In certain aspects, the taste-neutral cationic polymer is a cationic polymer synthesized from dimethylaminoethyl methacrylate and neutral methacrylic acid esters. The taste-neutral cationic polymer, for example, is an aminoalkyl methacrylate copolymer. Aminoalkyl methacrylate copolymers are available under the trade name of EUDRAGIT®, and include, for example, Eudragit E 100, Eudragit L 100-55, Eudragit L 100, Eudragit S-100, Eudragit E 12,5, Eudragit RL 100, Eudragit RL 30D, and the like. The chemical structures of Eudragit E and Eudragit L/S are shown below:

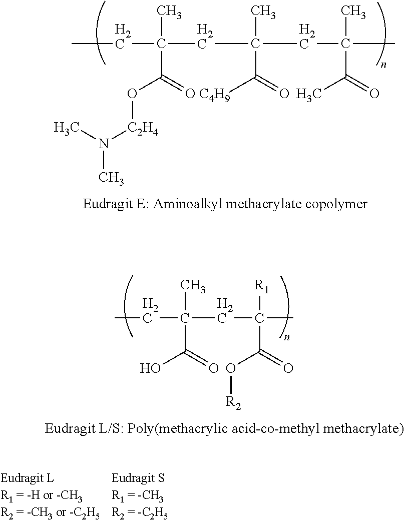

methacrylate-co-(2-dimethylamino ethyl) methacrylate-co-methyl methacrylate) 1:2:1) or Eudragit EPO. The amount of polymer in the nanoprecipitate is related to the amount of encapsulated cannabinoid. In certain aspects, the mass ratio of the taste-neutral cationic polymer to cannabinoid is at least about 1:3, or at least about 1:2.5. In yet additional aspects, the mass ratio of taste-neutral cationic polymer is about 1:2.2.

Reverse enteric polymers include, for example, methyl methacrylate and diethylaminoethyl methacrylate and the like, a copolymer comprising amino and/or alkylamino and/or dialkyl amino groups such as copolymers comprising methyl methacrylate and diethylaminoethyl methacrylate such as commercially available as KOLLICOAT® Smartseal 30 D from BASF, as well as those described in US 2006/062844 (2006); US 2005/0136114, U.S. Pat. No. 7,294,347, the contents of each of which are incorporated herein by reference.

The non-ionic surfactant can, for example, be an ethylene oxide/propylene oxide block copolymer, including, but not limited to, Polyoxyethylene (196), Polyoxypropylene (67) glycol, and poloxamer 407, or a mixture thereof. In certain aspects, the surfactant is poloxamer 407. In yet additional aspects, the surfactant is Poloxamer 407 wherein poloxamer 124 is not present. Exemplary surfactants also include PLURONIC® F68, polyvinyl alcohol (PVA), TWEEN® 80 Cremaphor EL, and food grade polysorbates 20, 60, 65, 80 and 81. The surfactant can, for example, be present in an amount or concentration of about 0.2 to about 1.0% (w/w). The cannabinoid(s) in the nanoprecipitate can, for example, be a cannabis extract (an extract from the Cannabis plant) and/or a synthetic cannabinoid. In certain aspects, the cannabinoid extract is a distillate. Cannabis plants belong to the family Cannabaceae, and include for example, Cannabis sativa, Cannabis indica, or Cannabis hybrid. A cannabinoid distillate can, for example, be a product of short path distillation of a cannabinoid extract. In certain aspects, the cannabinoid extract or distillate comprises total cannabinoid(s) in an amount or concentration selected from: 50-99 wt %, 75-99 wt %, 75-95 wt %, 80-99 wt %, 85-99 wt %, 90-99 wt %, 85-95 wt %, 90-95 wt %, or >99 wt % total cannabinoid(s). In additional aspects, the cannabinoid is one or more of a cannabis extract, tetrahydrocannabinol, Δ9-tetrahydrocannabinol (Δ9-THC), Δ8-tetrahydrocannabinol, tetrahydrocannabinolic acid (THCA), cannabigerolic acid (CBGA), cannabidiolic acid (CBDA), cannabinolic acid (CBNA), Δ8-tetrahydrocannabinol-DMH, Δ9-tetrahydrocannabinol propyl analogue (THCV), 11-hydroxy35 tetrahydrocannabinol, 11-nor-9-carboxy-tetrahydrocannabinol, 5′-azido-Δ8-tetrahydrocannabinol, AMG-1, AMG-3, AM411, AM708, AM836, AM855, AM919, AM926, AM938, cannabidiol (CBD), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabidiol propyl analogue (CBDV), cannabinol (CBN), cannabichromene (CBC), cannabichromene propyl analogue, cannabigerol (CBG), cannabicyclol (CBL), cannabielsoin (CBE), cannabinodiol (CBDL), and cannabitriol (CBTL), CP 47497, CP 55940, CP 55244, CP 50556, CT-3 or IP-751 (ajulemic acid), dimethylheptyl HHC, HU-210, HU-211, HU-308, WIN 55212-2, desacetyl-L-nantradol, dexanabinol, JWH-051, JWH-133, levonantradol, L-5 759633, nabilone, O-1184, cannabicyclohexanol (CP-47,497 C8 homolog), 10-hydroxycannabidiol, 1′,2′,3′,4′,5′-pentanorcannabinol-3-carboxylic acid, 1′-hydroxycannabinol, 11-hydroxycannabinol, 9-carboxy-11-norcannabinol, 1′-oxocannabinol, 11-nor-Δ8-THC-9-carboxylic acid, 2′-carboxy-3′,4′,5′-trinor-Δ9-THC, 5′-carboxy-Δ9-THC, 9-carboxy-11-nor-Δ9-THC, 9-carboxy-11-nor-Δ8-THC, [(6aR,10aR)-3-[(1S,2R)-1,2-dimethylheptyl]-6a,7,10,10a-tetrahydro-6,6,9-trimethyl-6H-dibenzo[b,d]pyran-1-ol], 9-carboxy-11-nor-(2 or 4)-chloro-Δ8-THC, 8α-11-dihydroxy-Δ9-THC, 8β-11-Dihydroxy-Δ9-THC, 5′-Dimethylamino-Δ8-THC, 11-hydroxy-Δ9-THC, 1′-hydroxy-Δ9-THC (Isomer B), 11-hydroxy-Δ8-THC, 2′-hydroxy-Δ9-THC, 3′-hydroxy-Δ9-THC, 4′-hydroxy-Δ9-THC, 5′-hydroxy-Δ9-THC, 8a-hydroxy-Δ9-THC, 80-hydroxy-Δ9-THC, 5′-methylamino-Δ8-THC, 5′-N-methyl-N-4-(7-nitrobenzofurazano)amino-Δ8-THC, (−)-trans-Δ8-THC, 5′-trimethylammonium-Δ8-THC phenolate, and 5′-Trimethylammonium-11-hydroxy-Δ8-THC phenolate.

In certain embodiments, the cannabinoid is selected from the group consisting of Δ9-THC, THCA, THCV, CBD, CBDA, CBDV, CBDL, CBC, CBCA, CBCV, CBCN, CBV, CBG, CBGA, CBGV, CBN, CBL, and CBE, or a combination of any of thereof. In additional aspects, the cannabinoid is one or more of Δ9-THC, CBD, THCA, CBDA, THCV, CBDV, or a combination thereof. In preferred aspects, at least one cannabinoid is Δ9-THC, for example, a distillate comprising Δ9-THC. In yet an additional aspect, at least one cannabinoid is CBD, for example a distillate comprising CBD. In further aspects, the encapsulated cannabinoids include Δ9-THC and CBD.

As discussed above, the nanoprecipitate can comprise a terpene. The terpene can, for example, be one found in Cannabis sativa, Cannabis indica, or Cannabis hybrid. In another example, the terpene is synthetic. In a further embodiment, the terpene is selected from one or more of the group consisting of: alpha-bisabolol, alpha-phellandrene, alpha-pinene, alpha-terpinene, alphaterpineol, beta-caryophyllene, beta-pinene, borneol, cadinene, camphene, camphor, carvacrol, caryophyllene acetate, caryophyllene oxide, cedrane, citral, citronellol, dextro carvone, dextro fenchone, eucalyptol (1,8-cineole), eugenol, farnesene, gama-3-carene, gamma-terpinene, geraniol, geranyl acetate, guaiene, humulene, isopulegol, limonene, linalool, linalyl acetate, menthol, myrcene, nerol, nerolidol, ocimene, ocimene, p-cymene, phytol, pulegone, terpineol, terpinen-4-ol, terpinolele, terpinolene, thymol, valencene, valencene,1-menthol, and combinations thereof. In yet additional aspects, the terpene is selected from the group consisting of alpha-bisabolol, alpha-phellandrene, alpha-pinene, alpha-terpinene, alphaterpineol, beta-pinene, borneol, cadinene, camphene, camphor, carvacrol, cedrane, citral, citronellol, dextro carvone, dextro fenchone, eucalyptol (1,8-cineole), eugenol, farnesene, gama-3-carene, gamma-terpinene, geraniol, geranyl acetate, guaiene, humulene, isopulegol, limonene, linalool, linalyl acetate, menthol, myrcene, nerol, nerolidol, ocimene, ocimene, p-cymene, phytol, pulegone, terpineol, terpinen-4-ol, terpinolele, terpinolene, thymol, valencene, valencene, 1-menthol, and combinations thereof.

Cannabinoids and/or terpenes can be obtained by separating resins from leaves, or leaves and flowers of cannabis plants by solvent extraction. Extracts derived from cannabis plants include primary extracts prepared by such processes as, for example, maceration, percolation, and solvent extraction. Solvent extraction can be carried out using a solvent that dissolves cannabinoids/cannabinoid acids, such as for example C₁-C₅ alcohols (e.g. ethanol, methanol), C₃-C₁₂ alkanes (e.g. hexane, butane or propane), Norflurane (HFA134a), HFA227, and carbon dioxide. General protocols for the preparation of extracts of cannabis plant material are described in U.S. Pat. App. Pub. No. 20060167283, the contents of which are expressly incorporated herein by reference. Carbon dioxide provides another method to extract cannabinoid/terpene resins from cannabis plant material. Sub Critical (Liquid) or Supercritical CO₂ is forced through the plant matter, which separates the cannabinoid/terpenes from the plant matter resulting in a transparent, amber oil. The extracts obtained by supercritical fluid extraction (SFE) may undergo a secondary extraction, e.g., an ethanolic precipitation, to remove non-cannabinoid/terpene materials. In a preferred embodiment, light petroleum gas extraction, using a LHBES (light hydrocarbon butane extraction system) 1300/C from Extractiontek Solutions is used to extract cannabinoids from cannabis plant material.

A modified extraction process consists of decarboxylating the starting concentrate at 300° F. until fully converted and the bubbling stops. Once the oil is decarboxylated, it is run through the VTA-VKL 70-5 short path rotary distillation plant twice. The first run separates the heavy terpenes and lighter terpenes from the cannabinoids and waste material. The cannabinoids and waste are run through again with a higher vacuum and higher temperature to separate the cannabinoids from the remaining waste. The waste is collected and run again in a larger batch to extract all cannabinoids and terpenes. The VTA-VKL 70-5 short path rotary distillation plant uses a top stirring rotary column to wipe incoming product into a thin film for better heat distribution and evaporation. The inner condensing column is set to condense the cannabinoids into liquids. The waste and cannabinoids are diverted into the two dispensing arms for collection into receiving vessels. The light terpenes are collected in a receiving flask attached to the inline chiller on the plant. The system (except for feed vessel) are under vacuum during the operation. The vacuum for the first run should be between 0.5-0.7 mbar. For the second run, pressure should be between 0.5-0.07 mbar.

In certain aspects, the nanoprecipitate has a z-average particle size is between about 20 to about 400 nm, about 25 to about 300 nm, about 30 to about 200 nm, about 40 to about 150 nm, about 50 to about 130 nm, or about 70 to about 300 nm.

The amount or concentration of cannabinoid, for example, Δ9-THC or CBD, in the nanoprecipitate can, for example, be between 0.0005 and 10% wt %, between about 0.001 and about 6 wt %, between about 0.001 and about 3 wt. %, or between about 0.001 to about 2%. The amount or concentration of Δ9-THC can, for example be between 0.1 and 10 wt %, between 0.1 and 6 wt %, or between about 0.1 to about 2 wt %.

In certain preferred aspects, at least one cannabinoid in the nanoprecipitate is Δ9-THC, CBD, THCA, CBDA, THCV, CBDV, or a combination thereof, the cationic polymer is Eudragit E 100, and the surfactant is Poloxamer 407. In yet additional aspects, at least one cannabinoid is Δ9-THC, the cationic polymer is Eudragit E 100, and the surfactant is Poloxamer 407. In yet further aspects, at least one cannabinoid is CBD, the cationic polymer is Eudragit E 100, and the surfactant is Poloxamer 407.

The nanoprecipitate or nanoparticle described herein can be prepared by a method comprising combining an aqueous phase and an organic phase wherein:
a. the aqueous phase comprises the non-ionic surfactant and water; and
b. the organic phase comprises the cannabinoid or the terpene, or a combination thereof, and the taste-neutral cationic polymer, and an organic solvent, wherein the organic solvent is miscible with water and wherein the taste-neutral cationic polymer and the cannabinoid are dissolved in the organic solvent;

wherein the volume of the aqueous phase is greater than that of organic phase and whereby a colloidal suspension comprising the nanoprecipitate is formed. In certain aspects, the nanoprecipitate comprises a cannabinoid. In certain aspects, the organic phase comprises a lipophilic antioxidant that is soluble in the organic solvent, including, but not limited to, phospholipid, Vitamin C-palmitate (ascorbyl palmitate), butylated hydroxyanisole, butylated hydroxy anisole, propyl gallate, Vitamin E (such as ∞-tocopherol or γ-tocopherol), and mixtures thereof. A preferred lipophilic antioxidant is ∞-tocopherol. Another preferred lipophilic antioxidant is ascorbyl palmitate.

The method can optionally further comprise the step i; or the steps i and ii:
i. removing at least a portion of the organic solvent to form an aqueous concentrate;
ii. diluting the aqueous concentrate with an aqueous solution to a desired concentration to form an aqueous suspension.

The combination of the organic phase and the aqueous phase is conducted while mixing or stirring. Generally, good or sufficient mixing conditions will result in a population of smaller nanoparticles versus the fewer larger particles that form under poor or insufficient mixing. The mixing rate is sufficient to result in colloidal dispersion with no visible aggregation. In some embodiments, the rate of mixing is about 400 to about 800 rpm at room temperature (20-25° C.).

Preferably, the organic phase is added to the aqueous phase, for example, the organic phase can be added to the aqueous phase while the aqueous phase is being mixed and at a controlled flow rate. The volume of the aqueous phase is greater than that of the organic phase; for example, the volume of the aqueous phase can be double that of the organic phase.

The organic solvent is a solvent in which the cationic polymer, e.g., EUDRAGIT® polymer, the cannabinoid, and/or the terpene are soluble, and that is miscible in water. Exemplary organic solvents are methanol, acetone, ethanol, ethyl acetate, acetonitrile, THF, DMF, DMSO, PEG, and solvent mixtures comprising any of these. In certain aspects, the organic solvent is methanol, ethanol, or acetone. A preferred organic solvent is methanol. For example, the cationic polymer is Eudragit E 100 and the organic solvent is methanol. The ratio of methanol to water in the colloidal suspension can be about 1:2. Another preferred organic solvent is ethanol. For example, the cationic polymer is Eudragit E 100 and the organic solvent is ethanol. The ratio of ethanol to water in the colloidal suspension can be about 1:2.

In certain aspects, the cannabinoid concentration in the organic phase is between about 0.4 to about 6 wt %, is between about 0.4 to about 1.7 wt %, or is between about 0.4 to about 0.9 wt %.

In certain aspects, the water of the aqueous phase is deionized (DI) water.

The aqueous phase can comprise an excipient such as a surfactant and such surfactants can minimize particle aggregation. Exemplary surfactants include those described above and PLURONIC® F68, Poloxamer 407, polyvinyl alcohol (PVA), TWEEN® 80, and Cremophor EL, or Kolliphor EL. In certain aspects, the aqueous phase is an aqueous solution comprising Poloxamer 407.

Step i can entail removing all or substantially all of the organic solvent to form the aqueous concentrate having the desired cannabinoid concentration. The organic solvent can be removed, for example, by evaporation, rotary evaporation, vacuum distillation, tangential flow filtration (TFF), ultracentrifugation, or freeze drying. In certain aspects, the organic solvent is removed by rotary evaporation. In additional aspects, the organic solvent is removed by TFF.

In step ii, the aqueous concentrate is diluted with an aqueous solution until the desired concentration of cannabinoid is achieved. The aqueous concentrate can, for example, be diluted with water and/or a weak acid with a low sour flavor impact such as phosphoric acid.

The method can further comprise adding a humectant to the aqueous concentrate or the aqueous suspension. The humectant can be added in an amount or concentration to reduce the water activity level to less than about 0.9, or less than about 0.88. Additional agents can be added to the aqueous concentrate such as preservatives and/or anti-microbial agents, such as potassium sorbate and/or sodium benzoate. Additional agents can be added to the aqueous concentrate such as water-soluble antioxidants, such as hydroxypropyl-β-cyclodextrins, sulfobutylether-β-cyclodextrin, α-cyclodextrin, Vitamin C and its salts, such as ascorbic acid or sodium ascorbate, propyl gallate, and mixtures thereof. A preferred water-soluble antioxidant is sodium ascorbate.

The method can further comprise the step of lyophilizing the nanoprecipitate, the aqueous concentrate or the aqueous suspension. The lyophilization step can include the addition of lyoprotectant including, for example, mannitol, sucrose and/or trehalose. In yet additional embodiments, the lyophilization step can comprise addition of a disaccharide, such as sucrose and trehalose, in an amount sufficient to disperse or solubilize the lyophilized product. In some examples, the amount or concentration sufficient to solubilize the lyophilized product is between about 5 and 15% (by weight). In yet additional aspects, the lyophilization step can comprise addition of a monosaccharide polyol such as mannitol in an amount sufficient to disperse or solubilize the lyophilized product.

In yet additional aspects, the method can comprise spray-drying the nanoprecipitate, the aqueous concentrate or the aqueous suspension. A spray-dried formulation can comprise an agent that increases the dispersion or solubility of the nanoprecipitate in a liquid. In certain aspects, the spray-dried formulation comprises a polyol, such as D-Mannitol, optionally in an amount sufficient to increase the solubility or dispersion of the spray-dried nanoprecipitate in an aqueous liquid. In yet further aspects, the spray-dried nanoprecipitate comprises CBD and the D-Mannitol:CBD ratio is about 100:1 to about 200:1, or preferably about 150:1.

In certain aspects, the polydispersity index (PDI) of the nanoprecipitate after addition to a liquid, such as an aqueous liquid or water, is less than about 0.2.

The invention encompasses oral formulations comprising the nanoprecipitate described herein. For example, the nanoprecipitate described herein can be used to prepare edibles, cannabinoid-infused food products, and/or terpene-infused food products. Encapsulation of the cannabinoid or the terpene, and/or the combination thereof, in the taste-neutral cationic polymer can render the food product sufficiently taste-masked or taste-neutral such that it is palatable or at least not unpleasant for oral consumption. Thus, the invention also encompasses a method of improving the taste profile and/or increasing the palatability of an oral formulation comprising a cannabinoid or terpene, or a combination thereof, comprising preparing an oral formulation comprising a nanoprecipitate, wherein the nanoprecipitate comprises a cannabinoid encapsulated by a taste-neutral cationic polymer, and further comprising a non-ionic surfactant. In certain aspects, the oral formulation is a food product. The invention also includes a method of masking the taste of a cannabinoid or a terpene, or a combination thereof, in an oral formulation, the method comprising preparing an oral formulation comprising a nanoprecipitate, wherein the nanoprecipitate comprises a cannabinoid encapsulated by a taste-neutral cationic polymer, and further comprising a non-ionic surfactant. The methods can further comprise administering the formulation to a subject or a patient. In additional aspects, the oral formulation is aqueous. The oral formulation can optionally comprise an additive or excipient. The additive or excipient can, for example, be a pharmaceutical grade additive or excipient, or a food grade additive or excipient.

In certain aspects, the formulation or food product provides immediate release of the cannabinoid and/or terpene. Specifically, the invention includes a cannabinoid-infused food product comprising a food carrier and a nanoprecipitate suspended in the food carrier, wherein the nanoprecipitate comprises a cannabinoid encapsulated by a taste-neutral cationic polymer, and wherein the nanoprecipitate further comprises a non-ionic surfactant. In some examples, the taste-neutral cationic polymer is an aminoalkyl methacrylate copolymer. The invention also includes a terpene-infused food product comprising a food carrier and a nanoprecipitate suspended in the food carrier, wherein the nanoprecipitate comprises a terpene encapsulated by a taste-neutral cationic polymer, and wherein the nanoprecipitate further comprises a non-ionic surfactant.

The food carrier is a food within which the nanoprecipitate described herein (comprising the cannabinoid and/or the terpene) can be suspended. In certain aspects, the food carrier is non-acidic or not highly acidic (for example, having a pH above 4, or a pH above 5, or a pH above 6). Exemplary food carriers include lozenges, candies (including hard candies/boiled sweets, lollipop, gummy candy, candy bar, etc.), chocolates, bakery products (including, for example, brownie, bread, pastry, cookie, muffins, pies, donuts), dissolving strips, crackers, mints, granola bars, protein bars, and energy bars. In yet additional aspects, the food carrier is a liquid or beverage. The liquid can, for example, be a non-acidic liquid or not highly acidic liquid. Exemplary liquids are drinking water, mineral coconut water, carbonated water, carbonated mineral water, tea, dairy milk, plant-based milk (such as almond milk, flax milk, cashew milk, and/or coconut milk), non-acidic juices (such as wheatgrass, cucumber carrot, aloe vera, cabbage juice, beet, watermelon, pear and spinach juices) and beer (including non-alcoholic beer). In additional aspects, the liquid is an acidic or not highly acid liquid (including, for example, sodas, juices, and sports drinks).

In certain specific aspects, the invention is directed to a cannabinoid infused food product comprising the nanoprecipitate. The cannabinoid infused food product can, for example, be an aqueous suspension comprising the nanoprecipitate, and optionally comprising an additive or excipient. The additive or excipient can, for example, be pharmaceutical grade additive or excipient, or a food grade additive or excipient.

In yet additional aspects, the invention is directed to a terpene infused food product. The terpene infused food product can also be an aqueous suspension comprising the nanoprecipitate, and optionally comprising an additive or excipient. The additive or excipient can, for example, be pharmaceutical grade additive or excipient, or a food grade additive or excipient.

In certain aspects, the cannabinoid or terpene infused food product is a beverage additive or beverage to which the beverage additive has been added or mixed. The beverage additive can be provided in a container or packet, such as a sachet or small bottle, and can be added to the beverage at or near the time of drinking. In certain aspects, the beverage additive is an aqueous suspension comprising the nanoprecipitate described herein in an aqueous solution, optionally further comprises a humectant such as glycerol. In certain aspects, the cannabinoid is in the aqueous suspension at a concentration between about 0.1 to about 0.9% w/v, for example, of about 0.4% w/v. For example, where the volume of the beverage additive is about 25 ml, the amount of cannabinoid can be at least about 0.5 mg, or at least about 2 mg, or at least about 5 mg, or at least about 10 mg. In certain aspects, the amount of cannabinoid in the concentrate is about 100 mg.

In yet additional aspects, the cannabinoid or terpene infused product is a ready-to-drink beverage comprising the nanoprecipitate.

The pH values of most beverages sold in the United States fall between 2.25 and 7.1; 39% of all beverages had a pH value <3.0, 54% had a pH value between 3.0 and 3.99, and 7% had a pH value >4.0, while phosphoric acid and citric acid were the most commonly used acidifiers [Reddy et al. J Am Dent Assoc. 2016 (4):255-63]. In certain aspects, the beverage comprising the cannabinoid (either a beverage to which the beverage additive is added or a beverage comprising a cannabinoid) is a beverage that has a pH between about 2.25 to about 7.1.

In certain aspects, the beverage comprising the cannabinoid or terpene (either a beverage to which the beverage additive is added or a beverage comprising a cannabinoid) is a non-acidic or not highly acidic beverage, such as drinking water, coconut water, tea, dairy milk, plant based milk (such as almond milk, flax milk, cashew milk, and/or coconut milk) and not highly acidic and non-acidic juices (such as wheatgrass, cucumber carrot, aloe vera, cabbage juice, beet, watermelon, pear and spinach juices). In some examples, when the aqueous suspension is added to the beverage, it emulsifies into a transparent or translucent emulsion after addition to the non-acidic beverage. In yet additional aspects, the suspension disperses within about 1 minute of gentle stirring. In yet additional aspects, the suspension disperses within about 30 seconds, about 25 seconds, or about 10 seconds of gentle stirring. In one example of a beverage, the beverage additive is added to an 8 ounce (about 237 ml) glass or bottle of drinking water and the amount of cannabinoid in the beverage is at least about 0.5 mg, at least about 2 mg, at least about 5 mg, or at least about 10 mg.

In yet further aspects, the beverage comprising the cannabinoid or terpene (either a beverage to which the beverage additive is added or a beverage comprising a cannabinoid) is an acidic or mildly acidic beverage, such as a soda (including, for example, colas, lemon lime sodas, orange sodas, and root beer), a sports drink, and a juice (including, for example, apple juice, orange juice, berry juice, tomato juice, pineapple juice, lemon juice, lemonade, cranberry juice, cranberry apple juice, mango juice, pomegranate juice, guava juice, fruit punch, and combinations thereof, as well as sparkling or carbonated juice drinks).

In certain preferred aspects, the amount of cannabinoid in the formulation (e.g., the beverage additive or beverage comprising the cannabinoid) is at least about 0.5 mg, at least about 1 mg, at least about 2 mg, at least about 5 mg, or at least about 10 mg. For example, the amount of cannabinoid in the beverage additive can be about 10 mg. In certain additional aspects, the amount of cannabinoid in the formulation is between about 0.25 mg to about 100 mg.

In certain aspects, the terpene infused food product is a beverage additive or beverage to which the beverage additive has been added or mixed. The beverage additive can be provided in a container or packet, such as a sachet or small bottle, and can added to the beverage at or near the time of drinking. In certain aspects, the beverage additive is an aqueous suspension comprising the nanoprecipitate described herein in an aqueous solution, optionally further comprising a humectant such as glycerol. In certain aspects, the beverage comprising the terpene (either a beverage to which the beverage additive is added or a beverage comprising a cannabinoid) is a non-acidic or not highly acidic beverage, such as drinking water, coconut water, tea, dairy milk, plant based milk (such as almond milk, flax milk, cashew milk, and/or coconut milk) and not highly acidic and non-acidic juices (such as wheatgrass, cucumber carrot, aloe vera, cabbage juice, beet, watermelon, pear and spinach juices). In yet additional aspects, the beverage comprising the terpene (either a beverage to which the beverage additive is added or a beverage comprising a cannabinoid) is an acidic or mildly acidic beverage, such as a soda (including, for example, colas, lemon lime sodas, orange sodas, and root beer), a sports drink, and a juice (including, for example, apple juice, orange juice, berry juice, tomato juice, pineapple juice, lemon juice, lemonade, cranberry juice, cranberry apple juice, mango juice, pomegranate juice, guava juice, fruit punch, and combinations thereof, as well as sparkling or carbonated juice drinks). In some examples, when the aqueous suspension is added to the beverage, it emulsifies into a transparent or translucent emulsion after addition to the non-acidic beverage. In yet additional aspects, the suspension disperses within about 1 minute of gentle stirring. In yet additional aspects, the suspension disperses within about 30 seconds, about 25 seconds, or about 10 seconds of gentle stirring. In one example of a beverage, the beverage additive is added to an 8 ounce (about 237 ml) glass or bottle of drinking water and the amount of cannabinoid in the beverage is at least about 0.5 mg, at least about 2 mg, at least about 5 mg, or at least about 10 mg.

With respect to beverage additives, the dilution ratio of beverage additive to beverage will depend on the composition of the beverage additive. In one embodiment, the beverage additive is diluted from 1:1-1,000 (i.e., 1 part beverage additive to 1-1,000 parts beverage). In further embodiments, the ratio is about 1:25-50, about 1:10-25, about 1:7.5-10, about 1:5-7.5, about 1:2.5-5, about 1:1-2.5, or about 1:1. In another embodiment the ratio of beverage additive to beverage is about 1:9-15 or about 1:10-11. The amount of beverage additive to be added or the dilution ratio will depend on the concentration of cannabinoid in the formulation or aqueous suspension and the volume of the beverage. The beverage additive can be formulated as a single use formulation (e.g., the desired amount of cannabinoid can be added to the beverage by emptying the entire contents of the container or packet to the beverage) or in a multi-use formulation (e.g. adding a few drops of the beverage additive to the beverage at each use).

The invention also includes a combination of the beverage additive and a beverage or a kit comprising the beverage additive and the beverage, wherein the beverage additive and the beverage are in separate containers or separate compartments of a container. For example, the beverage additive can be contained in a compartment in a cap/closure of a container.

The oral formulation or food product, for example, the beverage or the beverage additive, can further comprise additional components such as preservatives, antioxidants, surfactants, absorption enhancers, viscosity modifiers, coloring agents, pH modifiers, sweeteners, flavoring agents, taste-masking agents, nutraceuticals, vitamins, supplements, and/or GRAS agents. In certain aspects, the beverage or beverage additive comprises an antioxidant. In yet other aspects, the beverage or beverage additive comprising an antioxidant selected from Vitamin E, Vitamin C, their salts or esters, or a combination of any of thereof. In some embodiments, the antioxidant is a lipophilic antioxidant. In further embodiments, the beverage or beverage additive comprises Vitamin E. In some embodiments, the antioxidant is a hydrophilic antioxidant. In further embodiments, the beverage or beverage additive comprises sodium ascorbate. In specific aspects, the antioxidant is added in an amount sufficient to reduce oxidation and/or degradation of the formulation.

Exemplary preservatives are methylparabens, ethylparabens, propylparabens, butylparabens, sorbic acid, acetic acid, propionic acid, sulfites, nitrites, sodium sorbate, potassium sorbate, calcium sorbate, benzoic acid, sodium benzonate, potassium benzoate, calcium benzonate, sodium metabisulfite, propylene glycol, benzaldehyde, butylated hydroxytoluene, butylated hydroxyanisole, formaldehyde donors, essential oils, monoglyceride, and combinations thereof.

Exemplary sweeteners, flavoring and/or taste-masking agents include, for example, glucose, fructose, sucrose, sorbitol, sucralose, saccharin sodium, aspartame, neotame, acesulfame potassium, stevioside, sodium chloride, D-limonene, citric acid, xylitol and combinations thereof.

Exemplary pH adjusting agents are disodium hydrogen phosphate, sodium acetate, sodium bicarbonate, sodium phosphate tribasic, dipotassium hydrogen phosphate, phosphoric acid, acetic acid, lactic acid, fumaric acid, adipic acid, malic acid, tartaric acid, citric acid, hydrochloric acid, sulfuric acid, salts thereof, and combinations thereof. Viscosity modifying agents include, for example, unmodified starches, pregelatinized starches, crosslinked starches, guar gum, xanthan gum, acacia, tragacanth, carrageenans, alginates, chitosan, precipitated calcium carbonate (PCC), polyvinyl pyrrolidone, polyethylene oxide, polyethylene glycols (PEG), polycarbophils, hydroxymethylpropyl cellulose (HPMC), hydroxyethylcellulose (HEC), hydroxypropylmethylcelluose (HPC), carboxymethylcellose sodium (Na-CMC), ethylcellulose, cellulose acetate, and cellulose acetate phthalate, polyvinylacetate/polyvinylpyrrolidone (PVA/PVP), PVA/PEG graft copolymer, hydrogenated vegetable oils, polyglycolized esters of fatty acids, carnauba wax, stearyl alcohol, and beeswax, polyvinyl caprolactam-polyvinyl acetate-polyethylene glycol graft co-polymer, and combinations thereof.

Exemplary nutraceuticals and supplements are disclosed, for example, in Roberts et al., Nutraceuticals: The Complete Encyclopedia of Supplements, Herbs, Vitamins, and Healing Foods (American Nutraceutical Association, 2001), which is specifically incorporated by reference. Dietary supplements and nutraceuticals are also disclosed in Physicians' Desk Reference for Nutritional Supplements, 1st Ed. (2001) and The Physicians' Desk Reference for Herbal Medicines, 1st Ed. (2001), both of which are also incorporated by reference. A nutraceutical or supplement, can also be referred to as phytochemicals or functional foods, is generally any one of a class of dietary supplements, vitamins, minerals, herbs, or healing foods that have medical or pharmaceutical effects on the body.

Exemplary nutraceuticals or supplements include, but are not limited to, lutein, folic acid, fatty acids (e.g., DHA and ARA), fruit and vegetable extracts, vitamin and mineral supplements, phosphatidylserine, lipoic acid, melatonin, glucosamine/chondroitin, Aloe Vera, Guggul, glutamine, amino acids (e.g., arginine, iso-leucine, leucine, lysine, methionine, phenylalanine, threonine, tryptophan, and valine), green tea, lycopene, whole foods, food additives, herbs, phytonutrients, antioxidants, flavonoid constituents of fruits, evening primrose oil, flax seeds, fish and marine animal oils, and probiotics. Nutraceuticals and supplements also include bio-engineered foods genetically engineered to have a desired property, also known as “pharmafoods.”

The cannabinoid and/or terpene infused food product described herein can be prepared by a method comprising the step of preparing the food carrier in the presence of the nanoprecipitate; or adding the nanoprecipitate to the food carrier.

The choice of aminoalkyl methacrylate polymer or mixtures thereof can be used to tailor the desired release profile of the formulation comprising the nanoprecipitate. For example, where the aminoalkyl methacrylate polymer is Eudragit E 100, the formulation can be an immediate release formulation targeted to the stomach. In other examples, the formulation can be targeted to release the cannabinoids at different parts of the intestine based on the polymer encapsulating the cannabinoid. As shown, for example, in Table 4 below, the target organ for a formulation comprising Eudragit L100-55 is the duodenum.

In certain aspects, the nanoprecipitate does not comprise a starch.

As discussed above, the invention includes a method of improving the taste profile and/or increasing the palatability of an oral formulation comprising a cannabinoid or a terpene, or a combination thereof, comprising preparing an oral formulation comprising a nanoprecipitate as described herein. The method can further comprise administering the formulation to a subject or a subject or a patient. In additional aspects, the oral formulation is aqueous. In yet further aspects, the cannabinoid is Δ9-THC and/or CBD. In further aspects, the aminoalkyl methacrylate polymer is Eudragit E 100. In additional aspects, the oral formulation is a ready-to-drink beverage comprising the nanoprecipitate or a beverage to which a beverage additive comprising the nanoprecipitate has been added.

The invention additionally includes a method of masking the taste of a cannabinoid or a terpene, or a combination thereof, in an oral formulation, the method comprising preparing an oral formulation comprising a nanoprecipitate as described herein. The method can further comprise administering the formulation to a subject or a patient. In additional aspects, the oral formulation is aqueous. In yet further aspects, the cannabinoid is Δ9-THC and/or CBD. In further aspects, the aminoalkyl methacrylate polymer is Eudragit E 100. In additional aspects, the oral formulation is a ready-to-drink beverage comprising the nanoprecipitate or a beverage to which a beverage additive comprising the nanoprecipitate has been added.

The invention is illustrated by the following examples which are not meant to be limiting in any way.

### EXEMPLIFICATION

### Example 1

### Materials

THC-rich cannabis extract (THC-distillate) was supplied by New England Treatment Access (NETA, MA). Table 1 shows the cannabinoid composition of an exemplar THC-distillate batch as determined via high-performance liquid chromatography (HPLC).

TABLE 1
Exemplar HPLC cannabinoid content of THC-distillate.

| | Concentration |
|---|---|
| Cannabinoid | (wt. %) |
| Δ⁹-Tetrahydrocannabinol | 90.4 |
| Cannabinol | 1.4 |
| Cannabichromene | 1.1 |
| Tetrahydrocannabivarin | 0.5 |
| Δ⁸-Tetrahydrocannabinol | 0.5 |
| Cannabidivarin | <0.25 |
| Tetrahydrocannabinolic acid | <0.04 |
| Cannabidiolic acid | <0.03 |
| Cannabigerolic acid | <0.03 |
| Cannabidiol | <0.02 |
| Minimum cannabinoid content | 93.9 |

Basic butylated methacrylate copolymer (poly(butyl methacrylate-co-(2-dimethylamino ethyl) methacrylate-co-methyl methacrylate) 1:2:1, Eudragit E100) was purchased from Evonik Corporation. Ethylene oxide/propylene oxide block copolymer non-ionic surfactant (Polyoxyethylene (196) Polyoxylpropylene (67) glycol, Poloxamer 407) was purchased from BASF. Methanol, glycerin, sucrose and trehalose were purchased from Spectrum Chemical. De-ionized water was obtained via an in-house water purification system (Sartorius Arium Pro).

### Methods

1. Formulation

a. Preparation of Organic and Aqueous Phases

Organic phase was obtained by dissolving the active ingredient(s) (e.g., THC-distillate and/or other cannabinoids) and polymer (e.g., basic butylated methacrylate copolymer, Eudragit E 100) in organic solvent (e.g., methanol) at room temperature (20-25° C.) at predetermined concentration values. Aqueous phase was obtained by dissolving a non-ionic surfactant (e.g., ethylene oxide/propylene oxide block copolymer, Poloxamer 407) in cold (2-8° C.) de-ionized (DI) water at predetermined concentration values.

b. Nanoprecipitation

To facilitate nanoprecipitation of hydrophobic compounds (cannabinoids and de-protonated polymer) in aqueous media containing non-ionic surfactant, the organic phase was added to the aqueous phase in an appropriately-sized glass container at controlled flow rate. During the addition of the organic phase, the aqueous phase was stirred at constant rate (typically 400-800 rpm) at room temperature (20-25° C.). The aqueous phase was stirred either using a magnetic stir bar or an overhead stirrer. The flow of organic phase was controlled via a KD Scientific KDS-210 syringe pump at low flow rates (≤81 ml/min) or a Cole Parmer Masterflex I/P peristaltic pump at high flow rates (≥200 ml/min). The container for the aqueous phase was capped or covered during nanoprecipitation to prevent evaporation of organic solvent. A continuous stream of organic phase was fed into the aqueous phase vertically. To adjust the diameter of the stream of organic phase and/or to prevent pulsatile flow, the terminal tubing or syringe diameter was reduced by using a tubing adapter (peristaltic pump) or a needle (syringe pump).

c. Rotary Evaporation

Complete evaporation of organic solvent (e.g., methanol) followed by concentration of the aqueous phase to the target concentration was achieved using an Across International (NJ, USA) Solventvap 20 L rotary evaporator. Rotary evaporation was typically conducted at 60° C. at pressure values ranging from 40-200 mbar adjusted using a Buchi vacuum controller. Aqueous phase was typically concentrated beyond target cannabinoid concentration to enable further dilution.

d. Tangential Flow Filtration

Tangential Flow Filtration (TFF) was evaluated as an alternate and potentially more scalable clarification and concentration method vs. rotary evaporation. An exemplary TFF setup included a Repligen KR2i TFF System consisting of digital peristaltic pump and Easy-Load pump head, digital interface with a graphical LCD display, digital pressure monitor(s), automatic backpressure valve, module stand and data collection software, along with a flat-sheet (200 cm2 area, 300 kD molecular weight cut-off, Modified Polyethersulfone) TFF cassette (Repligen). An exemplary TFF process involved (1) an initial concentration of the cannabinoid payload in original solvent, (2) removal of methanol solvent via a buffer (e.g., deionized water or deionized water:glycerol-based solvent), and (3) a final concentration of cannabinoid payload.

e. Dilution (and Microbial Control)

The cannabinoid concentration of product was typically adjusted using DI water. In some compositions, a weak acid (e.g., phosphoric acid, pKa1=2.16) was added without buffer for pH titration (phosphoric acid was used because it has the least sour flavor impact of the organic food acids). In some compositions, a humectant (e.g., glycerol) was used to adjust the water activity below 0.88 to render products non-PHF (non-potentially hazardous food) or non-TCS (non-time/temperature control for safety) according to the Food Code (US Public Health Service, Food and Drug Administration, 2017, Subpart 1-201. Table A, page 22 and Table B, page 23). In some compositions, a preservative (e.g., potassium sorbate) was added for microbial control of yeast and mold growth.

f. Freeze-Drying

Lyophilized prototypes were produced using a bench-top manifold freeze-dryer (Labconco Freezone 2.5). To facilitate reconstitution of lyophilized nanoparticles in water, lyoprotectants such as monosaccharide polyols (e.g., mannitol) and disaccharides (e.g., sucrose, trehalose) were evaluated at different lyoprotectant concentration values and at different pre-lyophilization cannabinoid concentration values.

2. Characterization

a. Cannabinoid Content

An Agilent 1200 HPLC system equipped with a reverse-phase analytical column and a UV detector was employed to quantify 10 major cannabinoids (Δ9-tetrahydrocannabinol, Δ8-tetrahydrocannabinol, tetrahydrocannabinolic acid, cannabidiol, cannabidiolic acid, cannabinol, cannabichromene, tetrahydrocannabivarin, cannabidivarin and cannabigerolic acid). The absorbance signal at 220 nm was calibrated against a standard curve prepared using certified reference materials (Cerilliant, Texas). The accuracy and limit of quantitation (LOQ) values were typically 90-110% and ≤0.1%, respectively (with the exception of CBDV and THCA with LOQ values of 0.76% and 0.11%, respectively).

b. Particle Size Determination

Particle size distribution of colloidal dispersions was determined using a Malvern Zetasizer Nano ZS90 Dynamic Light Scattering (DLS) instrument. DLS measurements were collected in triplicate at 25° C. and 90° scattering angle. The z-average hydrodynamic particle diameter and polydispersity index (PDI) values, as well as volume-average particle size distribution plots were calculated using Zetasizer software provided by Malvern Instruments.

c. Water Activity

Water activity of aqueous products was measured using an Aqualab Pawkit water activity meter (Decagon, WA) after 3-point calibration using water activity standards provided by the manufacturer.

d. Shelf Life and Stability

Room temperature (20-25° C.) physical and chemical stability of aqueous emulsions were determined by comparing zero-time z-average particle size and PDI (measured via DLS) and cannabinoid content (measured via HPLC) with corresponding 3-month values. Room temperature (20-25° C.) and accelerated (33° C., Q10) shelf-life will be evaluated based on visual inspection of formulations and emulsions, formulation cannabinoid content, along with emulsion particle size.

e. Animal Pharmacokinetic (PK) Studies

Oral PK of cannabinoid nanoparticles will be assessed in beagle dogs using a crossover study design. Blood samples will be collected from a peripheral vein at pre-dose and at pre-determined timepoints post-dose, processed to plasma, and stored at ˜80±12° C. until analysis. The samples will be analyzed for cannabinoid concentration using a validated liquid chromatography/tandem mass spectroscopy (LC/MS-MS) method. A non-compartmental PK analysis will be conducted to determine Cₘₐₓ, AUC (0-24 h and 0-infinity), Tₘₐₓ, and t_{1/2} values.

f. Clinical Observational Studies

Clinical observational studies will be conducted to evaluate self-report psychoactive effects and symptom relief after oral administration of cannabinoid nanoparticle products. Study protocol will be reviewed and approved by an independent ethics committee, and all subjects will provide written informed consent. Subjects will be recruited from two Medical Marijuana (MM) dispensaries in the Greater Boston Area. Subjects will be asked to complete follow-up surveys (e.g., MM use behavior and effects) after each dispensary visit. All self-report data will be collected via secure online research portal and identified only by the subject's unique ID number.

### Results

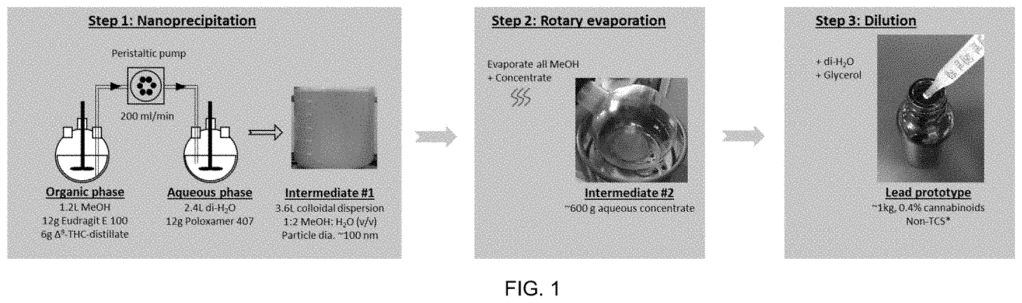

The nanoprecipitation method (including nanoprecipitation, rotary evaporation, and dilution) is summarized in FIG. 1.

The composition comprising the cannabinoid nanoprecipitate was consumed by volunteers in water. Based on self-report feedback, sufficient taste-masking and psychoactive effects were observed. This experimental work demonstrates the feasibility of taste-masked, colloidal cannabinoid solutions for oral administration as a liquid concentrate. In addition, the aqueous formulations were observed to be physically and chemically stable for over three months in the dark under ambient temperature conditions.

### Nanoprecipitation Step

Table 2 shows the composition of exemplary organic and aqueous phases during the nanoprecipitation step. THC distillate: Eudragit mass ratio in the organic phase was kept constant at 1:2.2.

TABLE 2

| | Organic phase | | | Aqueous phase | |
|---|---|---|---|---|---|
| | Distillate | E100 | Methanol | P407 | DI water |
| Form. # | mass (g) | mass (g) | vol. (ml) | mass (g) | vol. (ml) |
| 7-3-1 | 1.12 | 2.50 | 20 | 2.5 | 40 |
| 7-3-2 | 0.56 | 1.23 | 20 | 1.25 | 40 |
| 7-3-3 | 0.56 | 1.25 | 20 | 1.25 | 40 |
| 7-3-4 | 0.28 | 0.63 | 20 | 0.63 | 40 |
| 7-3-5 | 0.14 | 0.31 | 20 | 0.31 | 40 |

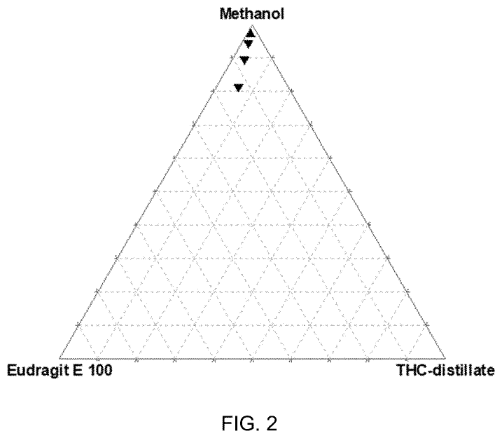

The aggregation propensity during the nanoprecipitation step versus the composition of the organic phase (by weight) is shown in FIG. 2. At higher THC-distillate concentration values (1.7-5.8 wt. %), the addition of organic phase to the aqueous phase led to immediate aggregation (see down triangles in FIG. 2). Reducing the THC-distillate concentration to ≤0.9 wt. % resulted in colloidal dispersions with no apparent aggregation (up triangles in FIG. 2). Nanoprecipitation parameters: flow rate (of organic phase)=2.4 ml/min; stir speed (of aqueous phase): 800 rpm.

Based on these results, a suitable THC concentration in the organic phase was determined as 0.6 wt. % (50% safety margin from 0.9 wt. % THC for THC-distillate: Eudragit mass ratio of 1:2).

Future studies may focus on the minimum E100: THC mass ratio for adequate taste masking and corresponding maximum THC concentration in organic phase.

### Rotary Evaporation Step

Cannabinoid concentration versus (reversible) aggregation propensity during the rotary evaporation step was studied pre-dilution (batch 1) and post-dilution (batch 2).

For batch 1 (assayed with no dilution), the gradual increase in both particle size and polydispersity with increasing cannabinoid concentration values >20 mg/ml suggest an increasing aggregation propensity at higher cannabinoid concentrations. For batch 2, when the z-average particle size and polydispersity values were assayed at a constant cannabinoid dilution, both attributes essentially remained constant. These results suggest that increasing cannabinoid concentrations due to rotary evaporation might lead to an increasing aggregation propensity while this aggregation may be reversible with further dilution with the studied cannabinoid concentration range (≤45 mg/ml).

Future studies may focus on determining pre-/post-dilution particles size distribution from the same batch to confirm that the aggregation is reversible.

Three-Month Ambient Stability and pH-Responsiveness of Aqueous THC:E100:P407 Nanoparticles

Table 3 shows the three-month, room temperature (20-25° C.) physical (DLS particle size distribution) and chemical stability (HPLC cannabinoid assay) of aqueous THC:Eudragit E100:Poloxamer 407 dispersions at neutral pH.

TABLE 3

| | Timepoint | Particle diameter | Cannabinoid |
|---|---|---|---|
| Form. # | (day) | (Z-ave, nm; PDI) | content (mg/ml) |
| 7-8-4 | 1 | 85; 0.23 | 6.3 |
| 7-8-4 | 90 | 86; 0.23 | 6.6 |

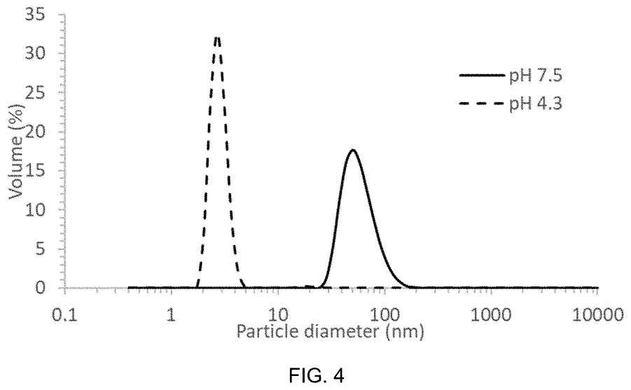

FIG. 4 shows the immediate dissolution of Eudragit E100 polymer upon pH titration to pH less than 5. Neutral (pH 7-8) aqueous THC: Eudragit E100: Poloxamer 407 dispersion was titrated to pH 4.3 using phosphoric acid.

### Targeted Delivery Using Acidic Polymethacrylate Copolymers

Different features of Eudragit polymers E100, L100-55, L100, and S100 are summarized below in Table 4:

TABLE 4

| | | Acidity/ | | |
|---|---|---|---|---|
| Form. # | Eudragit | basicity | pH-response | Target organ |
| 4-145-15 | E 100 | Basic | Soluble at pH <5.0 | Stomach, |
| | | | | immediate |
| | | | | release |
| 4-145-26 | L 100-55 | Acidic | Soluble at pH >5.5 | Duodenum |
| 4-145-37 | L 100 | Acidic | Soluble at pH >6.0 | Jejunum |
| 4-145-48 | S 100 | Acidic | Soluble at pH >7.0 | Ileum, Colon |

Attributes of the above-described formulation are described in Table 5:

TABLE 5

| | Particle dia. | Polydispersity | |
|---|---|---|---|
| Form. # | (z-ave, nm) | (AU) | pH |
| 4-145-15 | 159.0 | 0.07 | 7-8 |
| 4-145-26 | 75.9 | 0.15 | 4 |
| 4-145-37 | 79.9 | 0.12 | 5 |
| 4-145-48 | 124.5 | 0.14 | 5-6 |

### Example 2: Improving Lyophilized Product Solubility Using Disaccharides

Aqueous nanoparticle dispersions obtained by rotary evaporation were directly subjected to lyophilization to obtain solid prototypes. However, these lyophilized prototypes were insoluble in water. To enhance aqueous solubility of lyophilized products, possible effects of disaccharides, such as sucrose and trehalose on dispersion properties were evaluated. These evaluations were carried out at different disaccharide and cannabinoid concentration values (see TABLE 6).

TABLE 6
Composition of aqueous formulations prior to lyophilization.

| | Deionized | Nanoparticle | | Disaccharide |
|---|---|---|---|---|
| | Water Conc. | Conc. | Disaccharide | Conc. |
| Form. # | (wt. %) | (wt. %) | Name | (wt. %) |
| 9-10-8 | 94 | 1.0 | Sucrose | 5 |
| 9-10-9 | 89 | 1.0 | Sucrose | 10 |
| 9-10-10 | 84 | 1.0 | Sucrose | 15 |
| 9-10-11 | 94 | 1.0 | Trehalose dihydrate | 5 |
| 9-10-12 | 89 | 1.0 | Trehalose dihydrate | 10 |
| 9-10-13 | 84 | 1.0 | Trehalose dihydrate | 15 |

The aqueous compositions in TABLE 6 were lyophilized using a bench-top manifold freeze-dryer. After lyophilization, the aqueous dispersion properties of lyophilized prototypes were assessed visually, for particle size distribution using dynamic light scattering (DLS) and for emulsified cannabinoid concentration using high-performance liquid chromatography (HPLC) (TABLE 7). For both tested disaccharides, increasing disaccharide content led to improved solubility and dispersion properties. For example, with increasing sucrose concentration from 5 to 15 wt. %, the dispersed cannabinoid concentration determined via HPLC increased from 0.08 to 0.09 mg/ml, while the DLS z-average particle size decreased from 192 to 101 nm. Similarly, with increasing trehalose dihydrate concentration from 5 to 15 wt. %, the dispersed cannabinoid concentration increased from 0.05 to 0.1 mg/ml, while the z-average particle size decreased from 515 to 120 nm.

TABLE 7
Properties of 1.0 mg/ml aqueous emulsions of lyophilized prototypes
(pre-lyophilization compositions were listed in TABLE 6).

| | | | | | Dispersed |
|---|---|---|---|---|---|
| | | Visible | | Poly- | Cannabinoid |
| | Appear- | Particles | D | dispersity | Conc. |
| Form. # | ance | (Yes/No)* | (z-ave, nm) | (AU) | (mg/ml) |
| 9-10-8 | Turbid | Y | 192 | 0.47 | 0.08 |
| 9-10-9 | Turbid | Y | 116 | 0.47 | 0.08 |
| 9-10-10 | Turbid | N | 101 | 0.48 | 0.09 |
| 9-10-11 | Turbid | Y | 515 | 0.44 | 0.05 |
| 9-10-12 | Turbid | Y | 214 | 0.34 | 0.08 |
| 9-10-13 | Turbid | N | 120 | 0.42 | 0.10 |

### Example 3: Tangential Flow Filtration (TFF)

### 1. Background and Summary of Results

Solvent removal/concentration via rotary evaporation posed the following major limitations in terms of process scalability:
a. Extended process time and continuous process monitoring.
b. Lack of sufficient process controls results in batch to batch variability, such as product aggregation, which may potentially result in poor and unreliable product stability attributes.

Therefore, tangential flow filtration (TFF) was evaluated as an alternative solvent removal/concentration technology to facilitate pilot-scale cannabinoid nanoprecipitation. Based on these evaluations, the main advantages of TFF vs. rotary evaporation were:
a. Significantly shorter process time.
b. Built-in TFF process controls enable reproducible material with potentially improved stability profile.

The product obtained from TFF evaluations conformed all draft specifications, such as product appearance, THC yield, emulsion particle size and residual methanol solvent.

### 2. Detailed Results

a. Materials
   i. Repligen KR2i Tangential Flow Filtration (TFF) System consisting of digital peristaltic pump and Easy-Load pump head, digital interface with a graphical LCD display, digital pressure monitor(s), automatic backpressure valve, module stand and data collection software.
   ii. Flat-sheet, 200 cm² area, 300 kD MWCO, mPES TFF cassette (Repligen Part No.: PPL300LP2L).
   iii. Starting material: Δ⁹-THC nanoparticle emulsion obtained by nanoprecipitation according to MI AM.007. The composition of the starting material was 0.125% (w/v) Δ⁹-THC, 0.15% (w/v) basic methacrylate copolymer (Eudragit E100) and 0.15% (w/v) Poly(ethylene glycol)-block-poly(propylene glycol)-block-poly(ethylene glycol) (Poloxamer 407) in deionized water:methanol (3:1, v/v).

b. TFF Process Diagram and Test Data Summary

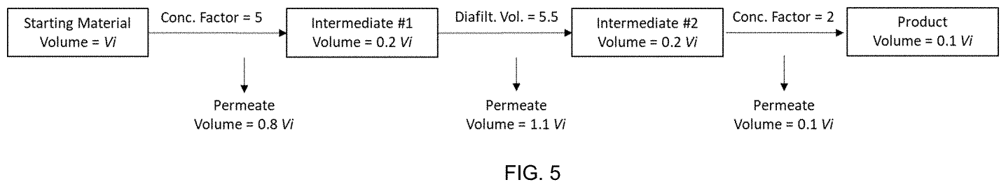

FIG. 5 summarizes the process employed for the removal of methanol solvent and 10-fold concentration of THC nanoparticle emulsions via TFF. The process consisted of 3 steps termed Concentration, Diafiltration and Concentration (CDC). These steps included (1) an initial 5-fold concentration of the THC payload in original buffer (deionized water:methanol, 3:1), (2) removal of methanol solvent via 5.5 diafiltration volumes of pure deionized water, and (3) a final 2-fold concentration of THC payload in deionized water. This process generated a permeate volume equal to twice that of the starting material (Vₚ=2·Vᵢ).

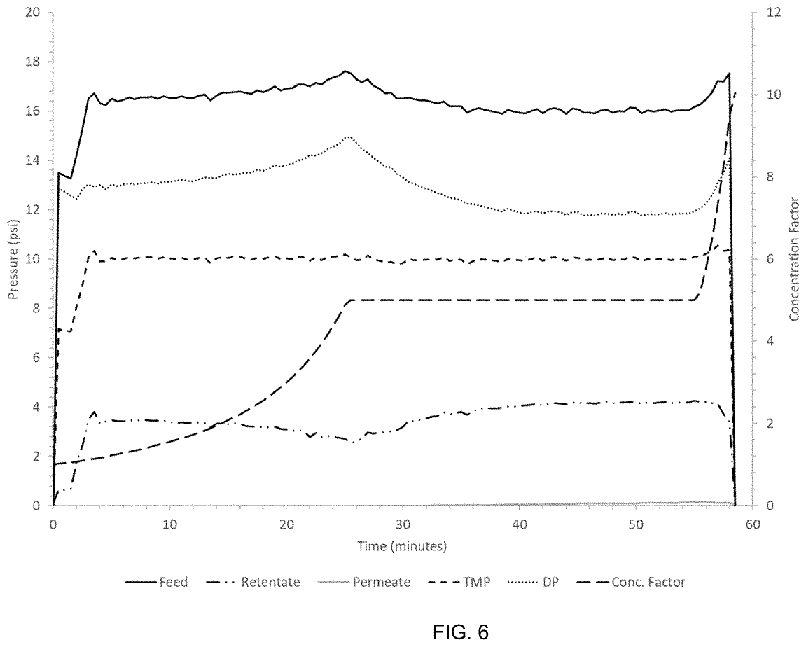

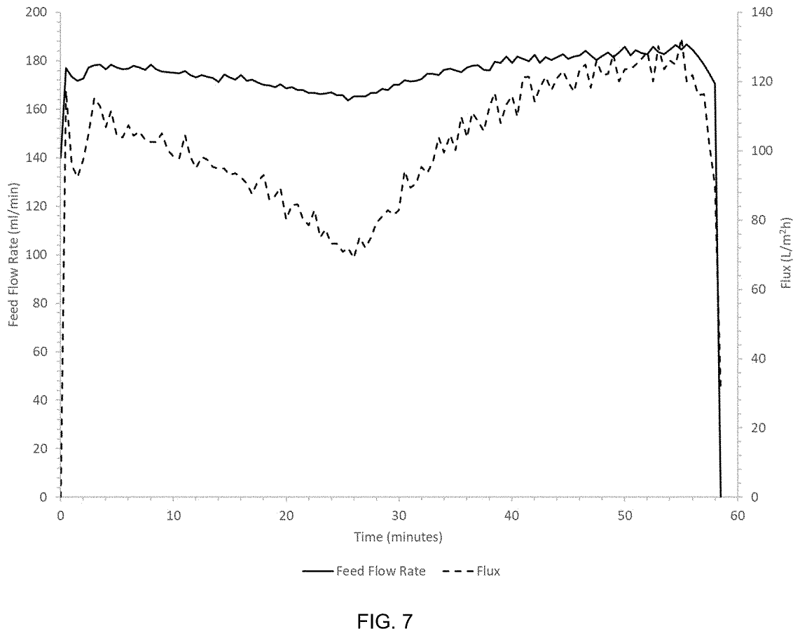

The pressure and concentration factor values were monitored throughout the process via built-in sensors and real-time data collection software of the lab-scale Repligen KR2i system (FIG. 6). Using the KR2i system equipped with a flat-sheet TFF cassette (Repligen PPL300LP2L, 200 cm², 300 kD MWCO, mPES membrane), 1 L starting material was processed in 1 hour. The test average flux (J) and average feed flow rate (Qᵢ) values were 102 L/m² h and 0.175 L/min (FIG. 7), respectively.

c. TFF Product Testing

The product of the lab-scale CDC TFF process was analyzed visually, via HPLC for cannabinoid yield and via DLS for emulsion particle size distribution, as well as via GPC for residual methanol content. The product conformed all target attributes, namely:
i. Appearance: Clear solution, slight pink color
ii. THC yield: 98.5%
iii. Particle size: 70 nm (5° C.), 74 nm (21° C.), 76 nm (60° C.)
iv. Residual Methanol: Conforms, <3,000 ppm

d. Scale-Up Estimations

Based on lab-scale CDC TFF test runs, the feasibility of pilot-scale nanoprecipitation using TFF was assessed. Two key TFF parameters, required cassette area and required pump flow rate were calculated as follows:

Using test flux (J) value of 102 L/m² h, the required cassette area (Aᵣ, units: m²) for a process time of (t, units: h) and starting material volume (Vᵢ, units: L) can be calculated according to Eq. 1:

$${A}_{r} = \frac{{V}_{p}}{J \cdot t} = \frac{2 \cdot {V}_{i}}{102 \cdot t} = \frac{{V}_{i}}{51 \cdot t} \qquad Eq . 1$$

Therefore, for a batch (starting material) volume of 100 L and a target process time of 5 hours, the required cassette area is approx. 0.39 m².

Using the test average feed flow rate (Qᵢ) and test cassette area (A) values of 0.175 L/min and 0.02 m², respectively, along with the required cassette area (Aᵣ, units: L) calculated from Eq. 1, the required pump flow rate (Qᵢᵣ, units: L/min) can be calculated according to Eq. 2:

$${Q}_{ir} = \frac{{Q}_{i}}{A} \cdot \frac{{V}_{i}}{51 \cdot t} = 0.172 \frac{{V}_{i}}{t} \qquad Eq . 2$$

For example, for a batch volume of 100 L and a process time of 5 hours, the required pump flow rate can be estimated as 3.44 L/min.

### Example 4: Identification of Critical Process Parameters for Cannabinoid Nanoprecipitation

Possible effects of different process parameters on emulsion particle size distribution were studied to identify critical process parameters for polymer-based cannabinoid production (Table 8). For this study, cannabinoid nanoprecipitate batches were prepared at either small scale (15-ml, Tables 8A and 8B) or intermediate scale (200-700 ml, Table 8C). For small-scale batches, studied process parameters included the type of cannabinoid ingredient (CBD or THC-distillate), the type of organic solvent (methanol, ethanol or acetone), the relative quantities of solutes and solvents, mixing speed of the aqueous phase, dispense rate of the organic phase, along with the temperature of organic and aqueous phases. At intermediate scale, studied process parameters included the dispense rate of the organic phase, and the dimensions and location of the organic phase dispensing tip with respect to the top surface of the aqueous phase. Possible correlations between process parameters and resulting emulsion particle size distribution were investigated by assuming a Gaussian distribution (Pearson correlation coefficients) and calculating two-tailed P-values with 95% confidence interval. Table 9 and Table 10 summarize the correlation analysis results of small and intermediate scale batches, respectively. The results obtained from small scale batches suggest that three of the tested parameters, namely Eudragit E100 polymer concentration, dispense rate of the organic phase (at constant dispensing tip orifice), and the cannabinoid ingredient could significantly affect the emulsion particle size distribution (p<0.05). According to the analysis of intermediate-scale batch data, besides critical process parameters identified at small scale, the dispensing tip orifice and the process scale could also significantly affect the emulsion particle size distribution (p<0.05).

TABLE 8A

| | | Organic | Organic Phase | Cannabinoid | E100 | P407 Mass |
|---|---|---|---|---|---|---|
| Form. # | Cannabinoid | Solvent | Volume (ml) | Mass (mg) | Mass (mg) | (mg) |
| 8-120-1 | THC Distillate | MeOH | 5 | 25 | 50 | 50 |
| 8-120-2 | THC Distillate | EtOH | 5 | 25 | 50 | 50 |
| 8-120-3 | CBD | MeOH | 5 | 25 | 50 | 50 |
| 8-120-4 | CBD | EtOH | 5 | 25 | 50 | 50 |
| 8-120-5 | THC Distillate | EtOH | 5 | 25 | 50 | 50 |
| 8-120-6 | THC Distillate | EtOH | 5 | 12.5 | 25 | 50 |
| 8-120-7 | THC Distillate | EtOH | 2.5 | 12.5 | 25 | 50 |
| 8-120-8 | THC Distillate | EtOH | 3 | 7.5 | 15 | 50 |
| 8-120-9 | THC Distillate | EtOH | 5 | 12.5 | 25 | 50 |
| 8-120-10 | THC Distillate | EtOH | 5 | 8.33 | 16.67 | 50 |
| 8-120-11 | THC Distillate | EtOH | 5 | 8.33 | 16.67 | 50 |
| 8-120-12 | THC Distillate | EtOH | 5 | 25 | 50 | 100 |
| 8-120-13 | THC Distillate | EtOH | 5 | 25 | 50 | 200 |
| 8-120-14 | THC Distillate | EtOH | 5 | 12.5 | 25 | 100 |
| 8-120-15 | THC Distillate | EtOH | 5 | 12.5 | 25 | 50 |
| 8-120-16 | THC Distillate | MeOH | 5 | 12.5 | 25 | 50 |
| 8-120-17 | THC Distillate | MeOH | 5 | 12.5 | 25 | 25 |
| 8-120-18 | THC Distillate | EtOH | 5 | 12.5 | 25 | 25 |
| 8-120-19 | THC Distillate | MeOH | 5 | 12.5 | 25 | 50 |
| 8-120-20 | THC Distillate | EtOH | 5 | 12.5 | 25 | 50 |
| 8-120-21 | THC Distillate | MeOH | 5 | 12.5 | 25 | 50 |
| 8-120-22 | THC Distillate | EtOH | 5 | 12.5 | 25 | 50 |
| 8-120-23 | THC Distillate | MeOH | 5 | 25 | 50 | 50 |
| 8-120-24 | THC Distillate | EtOH | 5 | 25 | 50 | 50 |
| 8-120-25 | THC Distillate | MeOH | 5 | 25 | 50 | 50 |
| 8-120-26 | THC Distillate | EtOH | 5 | 25 | 50 | 50 |
| 8-120-27 | THC Distillate | MeOH | 5 | 25 | 50 | 50 |
| 8-120-28 | THC Distillate | EtOH | 5 | 25 | 50 | 50 |
| 8-120-29 | THC Distillate | MeOH | 5 | 12.5 | 25 | 50 |
| 8-120-30 | THC Distillate | EtOH | 5 | 12.5 | 25 | 50 |
| 8-120-33 | THC Distillate | Acetone | 5 | 25 | 50 | 50 |
| 8-120-34 | THC Distillate | Acetone | 5 | 25 | 50 | 50 |
| 8-121-2 | THC Distillate | EtOH | 5 | 25 | 50 | 50 |
| 8-121-3 | THC Distillate | EtOH | 5 | 25 | 50 | 50 |
| 8-121-4 | THC Distillate | EtOH | 5 | 25 | 50 | 50 |
| 8-121-5 | THC Distillate | EtOH | 5 | 25 | 50 | 50 |
| 8-121-6 | THC Distillate | EtOH | 5 | 25 | 50 | 50 |
| 8-121-7 | THC Distillate | EtOH | 5 | 25 | 50 | 50 |
| 8-121-8 | THC Distillate | MeOH | 5 | 25 | 50 | 50 |
| 8-121-9 | THC Distillate | MeOH | 5 | 25 | 50 | 50 |
| 8-121-10 | THC Distillate | EtOH | 5 | 25 | 37.5 | 50 |
| 8-121-11 | THC Distillate | EtOH | 5 | 25 | 62.5 | 50 |
| 8-121-12 | THC Distillate | EtOH | 5 | 25 | 25 | 50 |
| 8-121-13 | THC Distillate | EtOH | 5 | 25 | 50 | 50 |
| 8-121-14 | THC Distillate | EtOH | 5 | 25 | 50 | 100 |
| 8-121-14R | THC Distillate | EtOH | 5 | 25 | 50 | 100 |
| 8-121-15 | THC Distillate | EtOH | 5 | 25 | 50 | 200 |
| 8-121-15R | THC Distillate | EtOH | 5 | 25 | 50 | 200 |
| 8-121-16 | THC Distillate | EtOH | 5 | 25 | 37.5 | 50 |
| 8-121-17 | THC Distillate | EtOH | 5 | 25 | 37.5 | 100 |
| 8-121-18 | THC Distillate | EtOH | 5 | 25 | 37.5 | 200 |
| 8-121-19 | THC Distillate | EtOH | 5 | 25 | 50 | 25 |
| 8-121-20 | THC Distillate | EtOH | 5 | 25 | 37.5 | 25 |
| 8-121-21 | THC Distillate | EtOH | 5 | 25 | 50 | 50 |
| 8-121-22 | THC Distillate | EtOH | 5 | 25 | 50 | 200 |
| 8-121-23 | THC Distillate | EtOH | 5 | 25 | 50 | 50 |
| 8-121-24 | THC Distillate | EtOH | 5 | 25 | 50 | 200 |
| 8-121-25 | THC Distillate | EtOH | 5 | 25 | 50 | 50 |
| 8-121-26 | THC Distillate | EtOH | 5 | 25 | 50 | 200 |
| 8-121-27 | THC Distillate | EtOH | 5 | 25 | 50 | 50 |
| 8-121-28 | THC Distillate | EtOH | 5 | 25 | 50 | 200 |
| 8-121-29 | THC Distillate | EtOH | 5 | 25 | 50 | 50 |
| 8-121-30 | THC Distillate | EtOH | 5 | 25 | 50 | 200 |
| 8-121-31 | THC Distillate | EtOH | 5 | 25 | 50 | 50 |
| 8-121-32 | THC Distillate | EtOH | 5 | 25 | 50 | 200 |
| 8-124-6 | THC Distillate | EtOH | 5 | 25 | 50 | 50 |
| 8-124-7 | THC Distillate | EtOH | 5 | 31.25 | 50 | 50 |
| 8-124-8 | THC Distillate | EtOH | 5 | 18.75 | 50 | 50 |
| 8-124-9 | THC Distillate | EtOH | 5 | 25 | 50 | 50 |
| 8-124-10 | THC Distillate | EtOH | 5 | 31.25 | 50 | 50 |
| 8-124-11 | THC Distillate | EtOH | 5 | 18.75 | 50 | 50 |
| 8-124-12 | THC Distillate | EtOH | 5 | 25 | 25 | 50 |
| 8-124-13 | THC Distillate | EtOH | 5 | 25 | 25 | 25 |
| 8-124-14 | THC Distillate | EtOH | 5 | 25 | 25 | 50 |
| 8-124-15 | THC Distillate | EtOH | 5 | 25 | 25 | 25 |
| 8-124-16 | THC Distillate | EtOH | 5 | 31.25 | 31.25 | 50 |
| 8-124-17 | THC Distillate | EtOH | 5 | 31.25 | 31.25 | 50 |
| 8-124-18 | THC Distillate | EtOH | 5 | 31.25 | 31.25 | 25 |
| 8-124-19 | THC Distillate | EtOH | 5 | 31.25 | 31.25 | 25 |
| 8-124-20 | THC Distillate | EtOH | 5 | 31.25 | 31.25 | 0 |
| 8-124-21 | THC Distillate | EtOH | 5 | 31.25 | 31.25 | 12.5 |
| 8-124-22 | THC Distillate | EtOH | 5 | 25 | 25 | 12.5 |
| 8-124-23 | THC Distillate | EtOH | 5 | 25 | 0 | 50 |
| 8-124-24 | THC Distillate | EtOH | 5 | 25 | 0 | 200 |
| 8-124-25 | THC Distillate | EtOH | 5 | 25 | 12.5 | 50 |
| 8-124-26 | THC Distillate | EtOH | 5 | 37.5 | 37.5 | 50 |
| 8-124-31 | THC Distillate | EtOH | 5 | 50 | 25 | 50 |
| 8-124-32 | THC Distillate | EtOH | 5 | 31.25 | 25 | 50 |
| 8-124-33 | THC Distillate | EtOH | 5 | 37.5 | 25 | 50 |
| 8-124-34 | THC Distillate | EtOH | 5 | 37.5 | 37.5 | 25 |
| 8-124-35 | THC Distillate | EtOH | 5 | 50 | 25 | 25 |
| 8-124-36 | THC Distillate | EtOH | 5 | 31.25 | 25 | 25 |
| 8-124-37 | THC Distillate | EtOH | 5 | 37.5 | 25 | 25 |

TABLE 8B

| | Aqueous Phase | Organic Phase | Organic | Aqueous | Particle | |
|---|---|---|---|---|---|---|
| | Stir Speed | Dispense Rate | Phase | Phase | Diameter | PDI |
| Form. # | (rpm) | (L/h) | Temp (° C.) | Temp (° C.) | (z-ave, nm) | (AU) |
| 8-120-1 | 650 | 1.2 | 21 | 21 | 149.3 | 0.067 |
| 8-120-2 | 650 | 1.2 | 21 | 21 | 168.5 | 0.081 |
| 8-120-3 | 650 | 1.2 | 21 | 21 | 180.9 | 0.026 |
| 8-120-4 | 650 | 1.2 | 21 | 21 | 177.6 | 0.094 |
| 8-120-5 | 1200 | 1.2 | 21 | 21 | 145.9 | 0.078 |
| 8-120-6 | 1200 | 1.2 | 21 | 21 | 100.2 | 0.077 |
| 8-120-7 | 1200 | 1.2 | 21 | 21 | 142 | 0.083 |
| 8-120-8 | 1200 | 1.2 | 21 | 21 | 98.16 | 0.1 |
| 8-120-9 | 1800 | 1.2 | 21 | 21 | 89.63 | 0.085 |
| 8-120-10 | 1200 | 1.2 | 21 | 21 | 84.72 | 0.087 |
| 8-120-11 | 1500 | 1.2 | 21 | 21 | 85 | 0.09 |
| 8-120-12 | 1200 | 1.2 | 21 | 21 | 145.1 | 0.081 |
| 8-120-13 | 1200 | 1.2 | 21 | 21 | 145.7 | 0.087 |
| 8-120-14 | 1200 | 1.2 | 21 | 21 | 104.3 | 0.113 |
| 8-120-15 | 1200 | 1.2 | 21 | 21 | 97.29 | 0.097 |
| 8-120-16 | 1200 | 1.2 | 21 | 21 | 91.85 | 0.118 |
| 8-120-17 | 1200 | 1.2 | 21 | 21 | 91.48 | 0.106 |
| 8-120-18 | 1200 | 1.2 | 21 | 21 | 102.5 | 0.103 |
| 8-120-19 | 1200 | 0.3 | 21 | 21 | 97.93 | 0.094 |
| 8-120-20 | 1200 | 0.3 | 21 | 21 | 93.59 | 0.105 |
| 8-120-21 | 1200 | 3.75 | 21 | 21 | 72.98 | 0.081 |
| 8-120-22 | 1200 | 3.75 | 21 | 21 | 89.98 | 0.116 |
| 8-120-23 | 1200 | 1.2 | 4 | 4 | 160.7 | 0.075 |
| 8-120-24 | 1200 | 1.2 | 4 | 4 | 149.1 | 0.064 |
| 8-120-25 | 1200 | 1.2 | 40 | 40 | 159.9 | 0.062 |
| 8-120-26 | 1200 | 1.2 | 40 | 40 | 145.9 | 0.072 |
| 8-120-27 | 1200 | 1.2 | 40 | 21 | 169.9 | 0.05 |
| 8-120-28 | 1200 | 1.2 | 40 | 21 | 144.9 | 0.112 |
| 8-120-29 | 1200 | 1.2 | 18 | 18 | 98.54 | 0.051 |
| 8-120-30 | 1200 | 1.2 | 18 | 18 | 101 | 0.085 |
| 8-120-33 | 1200 | 1.2 | 21 | 21 | 143.4 | 0.103 |
| 8-120-34 | 1200 | 1.2 | 21 | 21 | 144 | 0.076 |
| 8-121-2 | 1200 | 1.2 | 21 | 21 | 142.7 | 0.113 |
| 8-121-3 | 1200 | 1.2 | 21 | 21 | 138.9 | 0.036 |
| 8-121-4 | 1200 | 1.2 | 21 | 4 | 157.4 | 0.061 |
| 8-121-5 | 1200 | 1.2 | 21 | 4 | 146.1 | 0.07 |
| 8-121-6 | 1200 | 3.75 | 21 | 21 | 128.8 | 0.106 |
| 8-121-7 | 1200 | 3.75 | 21 | 4 | 132.2 | 0.098 |
| 8-121-8 | 1200 | 3.75 | 21 | 21 | 144.7 | 0.091 |
| 8-121-9 | 1200 | 3.75 | 21 | 4 | 171.2 | 0.135 |
| 8-121-10 | 1200 | 3.75 | 21 | 21 | 103.5 | 0.114 |
| 8-121-11 | 1200 | 3.75 | 21 | 21 | 153.3 | 0.087 |
| 8-121-12 | 1200 | 3.75 | 21 | 21 | 98.64 | 0.117 |
| 8-121-13 | 1200 | 3.75 | 21 | 21 | 138.8 | 0.079 |
| 8-121-14 | 1200 | 3.75 | 21 | 21 | 147 | 0.104 |
| 8-121-14R | 1200 | 3.75 | 21 | 21 | 148.9 | 0.078 |
| 8-121-15 | 1200 | 3.75 | 21 | 21 | 126 | 0.096 |
| 8-121-15R | 1200 | 3.75 | 21 | 21 | 126.6 | 0.117 |
| 8-121-16 | 1200 | 3.75 | 21 | 21 | 98.38 | 0.122 |
| 8-121-17 | 1200 | 3.75 | 21 | 21 | 101.4 | 0.107 |
| 8-121-18 | 1200 | 3.75 | 21 | 21 | 96.32 | 0.123 |
| 8-121-19 | 1200 | 3.75 | 21 | 21 | 134.7 | 0.084 |
| 8-121-20 | 1200 | 3.75 | 21 | 21 | 106.8 | 0.109 |
| 8-121-21 | 1200 | 3.75 | 21 | 21 | 127.9 | 0.089 |
| 8-121-22 | 1200 | 3.75 | 21 | 21 | 129 | 0.111 |
| 8-121-23 | 650 | 3.75 | 21 | 21 | 121.5 | 0.097 |
| 8-121-24 | 650 | 3.75 | 21 | 21 | 125.2 | 0.1 |
| 8-121-25 | 1200 | 1.2 | 21 | 21 | 142.6 | 0.081 |
| 8-121-26 | 1200 | 1.2 | 21 | 21 | 142 | 0.04 |
| 8-121-27 | 650 | 1.2 | 21 | 21 | 165.9 | 0.046 |
| 8-121-28 | 650 | 1.2 | 21 | 21 | 170 | 0.109 |
| 8-121-29 | 1200 | 3.75 | 21 | 21 | 123.9 | 0.083 |
| 8-121-30 | 1200 | 3.75 | 21 | 21 | 130.7 | 0.106 |
| 8-121-31 | 650 | 3.75 | 21 | 21 | 115.4 | 0.057 |
| 8-121-32 | 650 | 3.75 | 21 | 21 | 129.9 | 0.119 |
| 8-124-6 | 1200 | 3.75 | 21 | 21 | 127.3 | 0.137 |
| 8-124-7 | 1200 | 3.75 | 21 | 21 | 116.9 | 0.095 |
| 8-124-8 | 1200 | 3.75 | 21 | 21 | 131.6 | 0.101 |
| 8-124-9 | 650 | 3.75 | 21 | 21 | 125.5 | 0.098 |
| 8-124-10 | 650 | 3.75 | 21 | 21 | 112.6 | 0.135 |
| 8-124-11 | 650 | 3.75 | 21 | 21 | 127.8 | 0.12 |
| 8-124-12 | 650 | 3.75 | 21 | 21 | 80.12 | 0.114 |
| 8-124-13 | 650 | 3.75 | 21 | 21 | 83.57 | 0.108 |
| 8-124-14 | 1200 | 3.75 | 21 | 21 | 83.77 | 0.109 |
| 8-124-15 | 1200 | 3.75 | 21 | 21 | 85.12 | 0.091 |
| 8-124-16 | 1200 | 3.75 | 21 | 21 | 90.7 | 0.126 |
| 8-124-17 | 650 | 3.75 | 21 | 21 | 84.53 | 0.102 |
| 8-124-18 | 1200 | 3.75 | 21 | 21 | 92.96 | 0.105 |
| 8-124-19 | 650 | 3.75 | 21 | 21 | 87.32 | 0.125 |
| 8-124-20 | 650 | 3.75 | 21 | 21 | 374.5 | 0.085 |
| 8-124-21 | 650 | 3.75 | 21 | 21 | 89.9 | 0.13 |
| 8-124-22 | 650 | 3.75 | 21 | 21 | 84.54 | 0.055 |
| 8-124-23 | 650 | 3.75 | 21 | 21 | 29.27 | 0.124 |
| 8-124-24 | 650 | 3.75 | 21 | 21 | 29.27 | 0.067 |
| 8-124-25 | 650 | 3.75 | 21 | 21 | 56.61 | 0.119 |
| 8-124-26 | 650 | 3.75 | 21 | 21 | 89.21 | 0.112 |
| 8-124-31 | 650 | 3.75 | 21 | 21 | 67.58 | 0.109 |
| 8-124-32 | 650 | 3.75 | 21 | 21 | 74.11 | 0.1 |
| 8-124-33 | 650 | 3.75 | 21 | 21 | 70.37 | 0.122 |
| 8-124-34 | 650 | 3.75 | 21 | 21 | 93.02 | 0.138 |
| 8-124-35 | 650 | 3.75 | 21 | 21 | 74.28 | 0.117 |
| 8-124-36 | 650 | 3.75 | 21 | 21 | 75.17 | 0.106 |
| 8-124-37 | 650 | 3.75 | 21 | 21 | 78.04 | 0.053 |

TABLE 8C
The dependence of emulsion particle size distribution
on process parameters (intermediate scale batches).

| | | Organic Phase | Tip Inner | Tip to | Particle | |
|---|---|---|---|---|---|---|
| | Scale | Dispense Rate | Diameter | Aqueous Phase | Diameter | PDI |
| Form. # | (ml) | (L/h) | (mm) | Distance (mm) | (z-ave, nm) | (AU) |
| 8-125-1 | 600 | 0.88 | 0.84 | 2.5 | 91.65 | 0.167 |
| 8-125-2 | 600 | 0.88 | 6.35 | 2.5 | 145.2 | 0.105 |
| 8-125-3 | 600 | 0.88 | 0.84 | 7.5 | 87.75 | 0.198 |
| 8-125-4 | 600 | 0.88 | 2.69 | 7.5 | 124.6 | 0.094 |
| 8-125-5 | 600 | 0.88 | 2.69 | 7.5 | 125.4 | 0.086 |
| 8-125-6 | 600 | 0.88 | 1.19 | 7.5 | 86.01 | 0.203 |
| 8-125-7 | 600 | 0.88 | 0.84 | 7.5 | 84.76 | 0.199 |
| 8-125-8 | 600 | 0.67 | 1.19 | 7.5 | 92.98 | 0.15 |
| 8-125-9 | 600 | 0.43 | 1.19 | 7.5 | 101.6 | 0.133 |
| 8-125-10 | 2100 | 0.88 | 1.19 | 7.5 | 85.59 | 0.151 |
| 8-125-11 | 2100 | 0.88 | 1.19 | 0 | 77.93 | 0.15 |
| 8-125-12 | 2100 | 0.88 | 1.19 | 7.5 | 77.13 | 0.111 |
| 8-125-13 | 2100 | 0.88 | 1.19 | 0 | 71.36 | 0.143 |
| 8-125-14 | 900 | 0.88 | 1.19 | 7.5 | 83.02 | 0.131 |

TABLE 9
Correlation analysis results for small-scale batches.

| | Correlation of Parameter vs. Particle Diameter (z-ave, nm) | | | | | | |
|---|---|---|---|---|---|---|---|
| | Pearson r | | | | | | |
| | | 95% | | P-value | | | |
| | | confidence | | P (two- | P-value | Significance | Number of |
| Parameter | r | interval | R² | tailed) | Summary | (α < 0.05) | XY Pairs |
| E100 Mass (mg) | 0.6362 | 0.4968 to 0.7435 | 0.4047 | <0.0001 | **** | Yes | 93 |
| Organic Phase | 0.09047 | −0.1154 to 0.2889 | 0.008185 | 0.3884 | ns | No | 93 |
| Temp (° C.) | | | | | | | |
| Organic Solvent | 0.07797 | −0.1278 to 0.2773 | 0.006079 | 0.4576 | ns | No | 93 |
| (MeOH, EtOH, | | | | | | | |
| Acetone) | | | | | | | |
| Stir Speed (rpm) | 0.07326 | −0.1324 to 0.2729 | 0.005367 | 0.4853 | ns | No | 93 |
| P407 Mass (mg) | 0.03331 | −0.1716 to 0.2354 | 0.00111 | 0.7512 | ns | No | 93 |
| Cannabinoid | 0.02883 | −0.1759 to 0.2312 | 0.0008311 | 0.7838 | ns | No | 93 |
| Mass (mg) | | | | | | | |
| Organic Phase | −0.01284 | −0.2160 to 0.1914 | 0.0001649 | 0.9028 | ns | No | 93 |
| Volume (ml) | | | | | | | |
| Aqueous Phase | −0.1031 | −0.3005 to 0.1028 | 0.01063 | 0.3254 | ns | No | 93 |
| Temp (° C.) | | | | | | | |
| Polymer Lot | −0.1846 | −0.3763 to 0.02217 | 0.03409 | 0.0798 | ns | No | 91 |
| Cannabinoid | −0.2134 | −0.3998 to −0.01018 | 0.04556 | 0.0399 | * | Yes | 93 |
| (THC, CBD) | | | | | | | |
| Organic Phase | −0.2453 | −0.4277 to −0.04382 | 0.06019 | 0.0178 | ft | Yes | 93 |
| Dispense Rate | | | | | | | |
| (L/h) | | | | | | | |

TABLE 10
Correlation analysis results for intermediate scale batches.

| | Correlation of Parameter vs. Particle Diameter (z-ave, nm) | | | | | | |
|---|---|---|---|---|---|---|---|
| | Pearson r | | | P value | | | |
| | | 95% confidence | | P (two- | P-value | Significance | Number of |
| Parameter | r | interval | R² | tailed) | Summary | (α < 0.05) | XY Pairs |
| Tip Inner Dia. | 0.8638 | 0.6150 to 0.9561 | 0.7461 | <0.0001 | **** | Yes | 14 |
| (mm) | | | | | | | |
| Tip to Aqueous | 0.09496 | −0.4587 to 0.5955 | 0.009017 | 0.7468 | ns | No | 14 |
| Phase Distance (mm) | | | | | | | |
| Polymer Lot | 0.04957 | −0.4940 to 0.5653 | 0.002458 | 0.8663 | ns | No | 14 |
| Organic Phase | −0.06418 | −0.5752 to 0.4828 | 0.004119 | 0.8275 | ns | No | 14 |
| Dispense Rate (L/h) | | | | | | | |
| Scale (ml) | −0.5558 | −0.8390 to −0.03570 | 0.3089 | 0.0391 | * | Yes | 14 |

### Example 5: Possible Effects of Beverage Acidity on the Quality Attributes of Beverage Additive Formulations

According to a recent publication [Reddy et al. J Am Dent Assoc. 2016 (4):255-63], the pH values of most beverages sold in the United States fall between 2.25 and 7.1; 39% of all beverages had a pH value <3.0, 54% had a pH value between 3.0 and 3.99, and 7% had a pH value >4.0, while phosphoric acid and citric acid were the most commonly used acidifiers.

Table 11 shows the dependence of polymer-based cannabinoid emulsion appearance, turbidity, particle size distribution and cannabinoid strength as a function of diluent pH and acidifier (phosphoric or citric acid). Emulsions prepared with neutral buffer were translucent, while with decreasing pH a transition from translucent to transparent emulsions were observed (see Table 12, the apparent turbidity transition occurred between pH 3.0-3.1 for citric acid and at pH 3.6-3.7 for phosphoric acid dilutions). The decrease in emulsion turbidity with decreasing pH was correlated with an increase in particle size polydispersity (PDI), which could be attributed to the dissolution of Eudragit E100 polymer under acidic conditions. However, despite possible dissolution of polymer at low pH, there was no apparent decrease in cannabinoid strength over 2 hours storage at room temperature or during overnight refrigeration at low pH values. This suggests that polymer-based cannabinoid beverage additives will retain their stability upon dispersion in most beverages, i.e., polymer dissolution should not result in cannabinoid degradation within a reasonable duration from the dispersion of the formulation in a beverage to its consumption.

TABLE 11
Effects of Diluent pH on Quality Attributes

| | | | | | | Δ⁹-THC |
|---|---|---|---|---|---|---|
| | | | | Particle | | Strength |
| | | | Turbidity | Diameter | PDI | (HPLC Assay, |
| Acid | pH | Appearance | (NTU) | (z-ave, nm) | (AU) | %) |
| Phosphoric | 1.7 | Transparent | 8.1 | 104 | 0.45 | 112 |
| acid | 2.2 | Transparent | 12.5 | 89 | 0.49 | 99 |
| | 2.8 | Transparent | 3.3 | 82 | 0.35 | 109 |
| | 2.9-3.0 | Transparent | | | | |
| | 3.1-3.6 | Translucent | | | | |
| | 3.8 | Translucent | 27.6 | 78 | 0.09 | 97 |
| | 5.1 | Translucent | 29 | 71 | 0.09 | 96 |
| Citric acid | 1.5 | Transparent | 12 | 234 | 0.48 | 103 |
| | 2.3 | Transparent | 2.2 | 61 | 0.38 | 92 |
| | 3.0 | Transparent | 2 | 44 | 0.2 | 102 |
| | 3.1-3.6 | Transparent | | | | |
| | 3.8 | TL | 27.5 | 86 | 0.1 | 95 |
| | 4.8 | TL | 30 | 70 | 0.09 | 101 |
| | 7.0 | TL | 30 | 71 | 0.09 | 118 |

TABLE 12

| | Apparent Turbidity |
|---|---|
| Acid | Cross-over pH |
| Citric acid | 3.6-3.7 |
| Phosphoric acid | 3.0-3.1 |

### Example 6: Stability of Polymer-Based Cannabinoid Beverage Additive Formulations

A 3-month, room temperature (21° C.) stability study was conducted to estimate the room-temperature chemical stability of base Δ9-THC and CBD beverage additive formulations (Table 13). The room temperature shelf-life, i.e., the time required for 10% degradation of cannabinoid ingredient (t₉₀), was estimated by extrapolating the 3-month, HPLC cannabinoid assay data. The t₉₀ values for base Δ9-THC and CBD formulations were estimated as 24 and 196 weeks, respectively.

TABLE 13
Room temperature (21° C.) stability
of THC and CBD beverage additive formulations.

| | | Stability at Room Temperature (21° C.), HPLC Assay (%) | | | | |
|---|---|---|---|---|---|---|
| | Cannabinoid | | | | | Estimated t₉₀ |
| Form. # | ingredient | t₀ | Week 4 | Week 8 | Week 12 | (weeks) |
| 9-32-2 | THC-distillate | 100.0 | 99.5 | 96.4 | 96.4 | 24.0 |
| 9-33-2 | CBD | 99.7 | 99.2 | 99.4 | 100.0 | 196.4 |

### Example 7: Assessment of Formulation Parameters Affecting the Stability of Polymer-Based Beverage Additive Formulations Using a Statistical Design of Experiments (DOE) Approach

An experimental design (randomized ½ factorial design with a resolution of 3 and replicates on corner points) was generated to assess the formulation parameters affecting the stability of beverage additive formulations (Table 14). This design allowed for the determination of the main effects of formulation parameters that were convoluted with secondary formulation parameter effects. Specifically, the effects of 3 formulation parameters, cannabinoid type (CBD or THC-distillate), and the concentrations of a lipophilic (Vitamin E) and a hydrophilic (Vitamin C) antioxidant on the HPLC cannabinoid assay have been studied. In order to simulate long-term (>2 year) degradation at room temperature conditions within a reasonable timeframe, a forced degradation condition was identified as 1-2 weeks of incubation under extensive thermal stress (60° C.).

The results of this study (see Tables 15 and 16) indicated that all studied formulation parameters, namely the cannabinoid ingredient and the antioxidant type and concentration, significantly affected formulation stability (p<0.05). Δ9-THC-based formulas were more prone to degradation vs. CBD-based formulas. The stability of both CBD and Δ9-THC-based formulas could effectively be enhanced using antioxidants, suggesting oxidation was the main degradation mechanism. Further, lipophilic antioxidant, Vitamin E, was more effective than hydrophilic antioxidant, vitamin C in enhancing cannabinoid stability.

TABLE 14
Design of Experiments

| | | | Cannabinoid | | | Stability under |
|---|---|---|---|---|---|---|
| | | | Ingredient | Vitamin E | Vitamin C | Thermal Stress |
| Standard | Run | Center | (THC or | Conc. | Conc. | (60° C., Week 2), |
| Order | Order | Point | CBD) | (wt. %) | (wt. %) | HPLC Assay (%) |
| 5 | 1 | 1 | CBD | 0 | 0.25 | 89.2 |
| 8 | 2 | 0 | THC-distillate | 0.2 | 0.25 | 96.0 |
| 6 | 3 | 1 | THC-distillate | 0 | 0 | 72.1 |
| 9 | 4 | 1 | CBD | 0.1 | 0.125 | 95.0 |
| 7 | 5 | 1 | CBD | 0.2 | 0 | 100.1 |
| 4 | 6 | 1 | THC-distillate | 0.2 | 0.25 | 96.2 |
| 2 | 7 | 0 | THC-distillate | 0 | 0 | 72.8 |
| 1 | 8 | 1 | CBD | 0 | 0.25 | 90.1 |
| 10 | 9 | 1 | THC-distillate | 0.1 | 0.125 | 92.3 |
| 3 | 10 | 1 | CBD | 0.2 | 0 | 107.0 |

TABLE 15
Analysis of Variance of DOE results

| | Total | Adjusted | Adjusted | | |
|---|---|---|---|---|---|
| | Degrees of | Sums of | Mean | | |
| Source | Freedom | Squares | Squares | F-Value | P-Value |
| Model | 4 | 622.879 | 155.72 | 30.6 | 0.001 |
| Linear | 3 | 556.134 | 185.378 | 36.43 | 0.001 |
| Cannabinoid | 1 | 90.428 | 90.428 | 17.77 | 0.008 |
| (THC vs. CBD) | | | | | |
| Vitamin E | 1 | 433.062 | 433.062 | 85.11 | 0 |
| Vitamin C | 1 | 32.643 | 32.643 | 6.42 | 0.052 |
| Curvature | 1 | 5.385 | 5.385 | 1.06 | 0.351 |
| Error | 5 | 25.441 | 5.088 | | |
| Lack-of-Fit | 3 | 23.783 | 7.928 | 9.56 | 0.096 |
| Pure Error | 2 | 1.658 | 0.829 | | |
| Total | 9 | 648.32 | | | |

TABLE 16
Coefficients of DOE results

| | | | Standard | | | Variance |
|---|---|---|---|---|---|---|
| | | | Error of | | | Inflation |
| Term | Effect | Coefficient | Coefficient | T-Value | P-Value | Factor |
| Constant | 89.261 | 0.862 | 103.51 | 0 | | |
| Cannabinoid | −6.945 | −3.472 | 0.824 | −4.22 | 0.008 | 1.33 |
| (THC vs. | | | | | | |
| CBD) | | | | | | |
| Vitamin E | 18.394 | 9.197 | 0.997 | 9.23 | 0 | 1 |
| conc. (wt. %) | | | | | | |
| Vitamin C | 3.232 | 1.616 | 0.638 | 2.53 | 0.052 | 1 |
| conc. (wt. %) | | | | | | |
| Center Point | −2.12 | 2.06 | −1.03 | 0.351 | 1.33 | |

### Example 8: Stability of Ready-to-Drink Polymer-Based Cannabinoid Beverage Formulations

To mimic presentation of polymer-based cannabinoid formulas in potential ready to drink beverage formats, the stability of polymer-based Δ⁹-THC formulas was evaluated after their emulsification in 5 commercially available beverages. The cannabinoid stability (HPLC assay) was assessed under forced-degradation conditions similar to those applied in Example 7 (60° C., 4-7 days with or without fill headspace, Table 17). Beverages tested in this study included a commercially available bottled water, a carbonated flavored water, a carbonated flavored mineral water, and a non-alcoholic beer. For all tested beverages, the HPLC assay results indicated acceptable chemical stability (>9-12 months) can be achieved in commercially available bottled water, carbonated water (with or without added minerals) and non-alcoholic beer. Critical parameters affecting Δ⁹-THC stability were identified as antioxidant concentration, preservative concentration, and bottle fill headspace; increasing the antioxidant concentration generally enhanced formulation stability, while the removal of headspace facilitated improved stability at fixed antioxidant concentration.

TABLE 17

| | | | Stability under Thermal | |
|---|---|---|---|---|
| | | | Stress (60° C.), | |
| | Sodium | Potassium | HPLC Assay | |
| | Ascorbate | Sorbate | (% Δ⁹-THC) | |
| | Conc. of | Conc. of | With | No |
| Beverage No., | Beverage | Beverage | Headspace, | Headspace, |
| Type | (wt. %) | (wt. %) | Day 4 | Day 7 |
| 1, Bottled Water | 0 | 0 | 78.74 ± 7.11 | |
| | 0.2 | 0.025 | 77.89 ± 0.00 | |
| | 0.5 | 0.025 | 92.28 ± 1.59 | |
| | 0.2 | 0.05 | 87.35 ± 0.84 | |
| | 0.5 | 0.05 | 104.41 ± 0.68 | |
| 2, Carbonated | 0 | 0.025 | | 79.33 ± 2.57 |
| Flavored Water | 0.01 | 0.025 | | 72.90 ± 1.13 |
| | 0.02 | 0.025 | | 82.30 ± 0.28 |
| | 0.1 | 0.025 | | 96.50 ± 0.33 |
| 3, Carbonated | 0 | 0 | 86.97 ± 0.73 | |
| Flavored Mineral | 0.2 | 0.025 | 75.02 ± 1.76 | |
| Water | 0.5 | 0.025 | 85.26 ± 1.64 | |
| | 0.2 | 0.05 | 79.24 ± 1.38 | |
| | 0.5 | 0.05 | 87.87 ± 0.37 | |
| 4, Carbonated | 0 | 0.025 | | 74.42 ± 1.31 |
| Flavored Mineral | 0.01 | 0.025 | | 72.97 ± 0.71 |
| Water | 0.02 | 0.025 | | 80.33 ± 2.14 |
| | 0.1 | 0.025 | | 95.79 ± 0.02 |
| 5, Non-alcoholic | 0 | 0 | 35.61 ± 2.47 | |
| Beer | 0 | 0.025 | | 70.33 ± 1.54 |
| | 0.01 | 0.025 | | 86.10 ± 1.66 |
| | 0.02 | 0.025 | | 93.24 ± 0.70 |
| | 0.1 | 0.025 | | 93.49 ± 2.90 |
| | 0.2 | 0.025 | 67.65 ± 3.13 | |
| | 0.5 | 0.025 | 86.21 ± 1.81 | |
| | 0.2 | 0.05 | 74.96 ± 1.66 | |
| | 0.5 | 0.05 | 90.15 ± 0.76 | |

### Example 9: Feasibility of Spray-drying to Obtain Solid, Polymer-based Cannabinoid Formulations

### Methods

Spray-Drying

Spray-dried prototypes were produced using a Buchi Mini Spray Dryer B-290 operated in open loop configuration with de-humidification of inlet air using the Buchi B-296 Dehumidifier. To facilitate reconstitution of spray-dried nanoparticles in water, a monosaccharide polyol, D-mannitol, was evaluated at 15 wt. % with different cannabidiol (CBD) concentration values. Table 18 summarizes the B-290 spray-dryer instrument settings and operating conditions.

TABLE 18
Buchi B-290 instrument settings and operating conditions.

| B-290 Spray Dryer Set-points | | | | | Operating conditions | |
|---|---|---|---|---|---|---|
| Inlet Temp, | Aspirator, | Pump, | Nozzle | Nitrogen | Inlet | Outlet |
| ° C. | % | % | cleaner (AU) | Flow (L/h) | Temp, ° C. | Temp, ° C. |
| 150 | 100% | 20% | 3 | 54 | 149 | 96 |

Improving Spray-Dried Formulation Solubility Using Polyols

Aqueous nanoparticle dispersions obtained by tangential flow filtration (TFF) were directly subjected to spray-drying to obtain solid prototypes. However, these spray-dried prototypes were insoluble in water. To improve the aqueous solubility of spray-dried products, the effect of including the polyol D-Mannitol on dispersion properties was evaluated. These evaluations were carried out at 15 wt. % Mannitol and different cannabidiol (CBD) concentration values (Table 19).

TABLE 19
Composition and particle size of aqueous formulations prior to spray-drying.

| | Deionized | CBD | | Excipient | | | |
|---|---|---|---|---|---|---|---|
| | Water Conc. | Conc. | Excipient | Conc. | Mannitol:CBD | Particle Dia. | |
| Form. # | (wt. %) | (wt. %) | Type | (wt. %) | Mass Ratio | (z-ave, nm) | PDI |
| 8-122-4 | 84.9 | 0.1 | D-Mannitol | 15 | 150 | 139.8 | 0.05 |
| 8-122-1 | 84.75 | 0.25 | D-Mannitol | 15 | 60 | 139.9 | 0.08 |

The aqueous compositions in Table 19 were spray-dried using a BUCHI Mini Spray Dryer B-290 with B-296 Dehumidifier. After spray-drying, the aqueous dispersion properties of the prototypes were assessed visually, and particle size distribution determined using dynamic light scattering (DLS) (Table X13). The mass ratio of Mannitol/CBD was an important factor influencing the dispersibility upon re-constitution of spray-dried product in DI water at a target CBD concentration of 1 mg/ml. Upon reconstitution, samples prepared with the Mannitol/CBD mass ratio=60 were visually hazy (not fully dissolved) with a particle size by DLS of 260.1 nm and large polydispersity (>0.2). In comparison, samples prepared with a Mannitol/CBD mass ratio=150 were clear (fully dissolved) with a particle size by DLS of 193.9 nm and acceptable polydispersity (<0.2).

TABLE 20
Properties of spray-dried prototypes after reconstitution
in DI water at a target CBD concentration of 1 mg/ml.

| | | | Visible | Particle | |
|---|---|---|---|---|---|
| | Mannitol:CBD | Appear- | Particles | Diameter | |
| Form. # | Mass Ratio | ance | (Yes/No)* | (z-ave, nm) | PDI |
| 8-122-4 | 150 | Clear | No | 193.9 | 0.19 |
| 8-122-1 | 60 | Hazy | Yes | 260.1 | 0.54 |

While this invention has been particularly shown and described with references to preferred embodiments thereof, it will be understood by those skilled in the art that various changes in form and details may be made therein without departing from the scope of the invention encompassed by the appended claims.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications and references cited herein are incorporated by reference in their entirety.

1. A nanoprecipitate comprising a cannabinoid or a terpene, or a combination thereof, wherein the cannabinoid or terpene, or combination thereof, is encapsulated by a taste-neutral cationic polymer, and wherein the nanoprecipitate further comprises a non-ionic surfactant, wherein the taste-neutral cationic polymer is an aminoalkyl methacrylate copolymer.

2. The nanoprecipitate of claim 1, wherein the aminoalkyl methacrylate copolymer is (poly(butyl methacrylate-co-(2-dimethylamino ethyl) methacrylate-co-methyl methacrylate) 1:2:1 (Eudragit E100).

3. The nanoprecipitate of claim 1, wherein the non-ionic surfactant is an ethylene oxide/propylene oxide block copolymer.

4. The nanoprecipitate of claim 3, wherein the surfactant is poloxamer 407.

5. The nanoprecipitate of claim 1, comprising a cannabinoid.

6. The nanoprecipitate of claim 1, comprising a terpene.

7. (canceled)

8. The nanoprecipitate of claim 1, wherein the cannabinoid is one or more of tetrahydrocannabinol, Δ9-tetrahydrocannabinol (Δ9-THC), Δ8-tetrahydrocannabinol, a cannabis extract, tetrahydrocannabinolic acid (THCA), cannabigerolic acid (CBGA), cannabidiolic acid (CBDA), cannabinolic acid (CBNA), Δ8-tetrahydrocannabinol-DMH, Δ9-tetrahydrocannabinol propyl analogue (THCV), 11-hydroxy35 tetrahydrocannabinol, 11-nor-9-carboxy-tetrahydrocannabinol, 5′-azido-Δ8-tetrahydrocannabinol, AMG-1, AMG-3, AM411, AM708, AM836, AM855, AM919, AM926, AM938, cannabidiol (CBD), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabidiol propyl analogue (CBDV), cannabinol (CBN), cannabichromene (CBC), cannabichromene propyl analogue, cannabigerol (CBG), cannabicyclol (CBL), cannabielsoin (CBE), cannabinodiol (CBDL), and cannabitriol (CBTL), CP 47497, CP 55940, CP 55244, CP 50556, CT-3 or IP-751 (ajulemic acid), dimethylheptyl HHC, HU-210, HU-211, HU-308, WIN 55212-2, desacetyl-L-nantradol, dexanabinol, JWH-051, JWH-133, levonantradol, L-5 759633, nabilone, O-1184, cannabicyclohexanol (CP-47,497 C8 homolog), 10-hydroxycannabidiol, 1′,2′,3′,4′,5′-pentanorcannabinol-3-carboxylic acid, 1′-hydroxycannabinol, 11-hydroxycannabinol, 9-carboxy-11-norcannabinol, 1′-oxocannabinol, 11-nor-Δ8-THC-9-carboxylic acid, 2′-carboxy-3′,4′,5′-trinor-Δ9-THC, 5′-carboxy-Δ9-THC, 9-carboxy-11-nor-Δ9-THC, 9-carboxy-11-nor-Δ8-THC, [(6aR,10aR)-3-[(1 S,2R)-1,2-dimethylheptyl]-6a,7,10,10a-tetrahydro-6,6,9-trimethyl-6H-dibenzo[b,d]pyran-1-ol], 9-carboxy-11-nor-(2 or 4)-chloro-Δ8-THC, 8-11-dihydroxy-Δ9-THC, 8β-11-Dihydroxy-Δ9-THC, 5′-Dimethylamino-Δ8-THC, 11-hydroxy-Δ9-THC, 1′-hydroxy-Δ9-THC (Isomer B), 11-hydroxy-Δ8-THC, 2′-hydroxy-Δ9-THC, 3′-hydroxy-Δ9-THC, 4′-hydroxy-Δ9-THC, 5′-hydroxy-Δ9-THC, 8a-hydroxy-Δ9-THC, 80-hydroxy-Δ9-THC, 5′-methylamino-Δ8-THC, 5′-N-methyl-N-4-(7-nitrobenzofurazano)amino-Δ8-THC, (−)-trans-Δ8-THC, 5′-trimethylammonium-Δ8-THC phenolate, and 5′-Trimethylammonium-11-hydroxy-Δ8-THC phenolate.

9. The nanoprecipitate of claim 8, wherein the cannabinoid is one or more of Δ9-THC, CBD, THCA, CBDA, THCV, CBDV, or a combination thereof.

10. The nanoprecipitate of claim 9, wherein at least one cannabinoid is Δ9-THC.

11. The nanoprecipitate of claim 10, wherein the cationic polymer is Eudragit E 100 and the surfactant is Poloxamer 407.

12. The nanoprecipitate of claim 9, wherein at least one cannabinoid is CBD.

13. The nanoprecipitate of claim 12, wherein the cationic polymer is Eudragit E 100 and the surfactant is Poloxamer 407.

14. The nanoprecipitate of claim 1, wherein the z-average particle size is between about 25 to about 200 nm.

15. An oral formulation comprising an aqueous suspension of the nanoprecipitate of claim 1 in an aqueous solution, wherein the suspension optionally further comprises a humectant.

16. A beverage additive comprising an aqueous suspension of the nanoprecipitate of claim 1 in an aqueous solution, wherein the suspension optionally further comprises a humectant.

17. (canceled)

18. The beverage additive of claim 16, wherein the cannabinoid in the aqueous suspension is at a concentration of about 1% w/v or wherein the amount of cannabinoid in the suspension is at least about 10 mg.

19. (canceled)

20. The beverage additive of claim 16, wherein, after addition to a non-acidic beverage, the suspension emulsifies into a transparent to translucent emulsion.

21. (canceled)

22. A nanoprecipitate comprising a cannabinoid or a terpene, or a combination thereof, wherein the nanoprecipitate is prepared by a method comprising combining an aqueous phase and an organic phase wherein:
a. the aqueous phase comprises the non-ionic surfactant and water; and
b. the organic phase comprises the cannabinoid or the terpene or the combination thereof, the taste-neutral cationic polymer, and an organic solvent, wherein the organic solvent is miscible with water and wherein the taste-neutral cationic polymer and the cannabinoid are dissolved in the organic solvent;
wherein the volume of the aqueous phase is greater than that of organic phase and whereby a colloidal suspension comprising the nanoprecipitate is formed.

23-29. (canceled)

30. A method of preparing the nanoprecipitate of claim 1, comprising combining an aqueous phase and an organic phase wherein:
a. the aqueous phase comprises the non-ionic surfactant and water; and
b. the organic phase comprises the cannabinoid or a terpene, or a combination thereof, and the taste-neutral cationic polymer, and an organic solvent, wherein the organic solvent is miscible with water and wherein the taste-neutral cationic polymer and the cannabinoid are dissolved in the organic solvent;
wherein the volume of the aqueous phase is greater than that of organic phase and whereby a colloidal suspension comprising the nanoprecipitate is formed.

31-37. (canceled)

38. A cannabinoid infused food product comprising a food carrier and a nanoprecipitate suspended in the food carrier, wherein the nanoprecipitate comprises a cannabinoid encapsulated by a taste-neutral cationic polymer, and wherein the nanoprecipitate further comprises a non-ionic surfactant.

39. The cannabinoid infused food product of claim 38, wherein the taste-neutral cationic polymer is an aminoalkyl methacrylate copolymer.

40. The cannabinoid infused food product of claim 39, wherein the aminoalkyl methacrylate copolymer is (poly(butyl methacrylate-co-(2-dimethylamino ethyl) methacrylate-co-methyl methacrylate) 1:2:1 (Eudragit E100).

41. The cannabinoid infused food product of claim 38, wherein the food carrier is a liquid or a beverage.

42. The cannabinoid infused food product of claim 41, wherein the liquid is an aqueous solution and the food product is an aqueous suspension of the nanoprecipitate, wherein the suspension optionally further comprises a humectant.

43-45. (canceled)

46. The cannabinoid infused food product of claim 38, wherein the food product is a beverage or a beverage additive.

47. The cannabinoid infused food product of claim 46, wherein, after addition to a non-acidic beverage, the suspension emulsifies into a transparent to translucent emulsion.

48. The cannabinoid infused food product of claim 47, wherein the non-acidic beverage is drinking water.

49. The cannabinoid infused food product of claim 38, wherein the food carrier is a candy, chocolate, or a bakery product.

50-53. (canceled)

54. The cannabinoid infused food product of claim 38, wherein the cannabinoid is one or more of Δ9-THC, CBD, THCA, CBDA, THCV, CBDV, or a combination thereof.

55. The cannabinoid infused food product of claim 54, wherein at least one cannabinoid is Δ9-THC or CBD.

56. The cannabinoid infused food product of claim 55, wherein the cationic polymer is Eudragit E 100 and the surfactant is Poloxamer 407.

57. (canceled)

58. (canceled)

59. The cannabinoid infused food product of claim 38, wherein the z-average particle size of the nanoprecipitate is between about 25 to about 150 nm.

60. A method of preparing a cannabinoid infused food product of claim 38 comprising the step of preparing the food carrier in the presence of the nanoprecipitate; or adding the nanoprecipitate to the food carrier.

61. (canceled)

62. (canceled)

63. A terpene infused food product comprising a food carrier and a nanoprecipitate suspended in the food carrier, wherein the nanoprecipitate comprises a terpene encapsulated by a taste-neutral cationic polymer, and wherein the nanoprecipitate further comprises a non-ionic surfactant.

64-70. (canceled)

71. A method of preparing the terpene infused food product of claim 63 comprising the step of preparing the food carrier in the presence of the nanoprecipitate; or adding the nanoprecipitate to the food carrier.

72. (canceled)

73. (canceled)

74. A method of improving the taste profile and/or increasing the palatability of an oral formulation comprising a cannabinoid or a terpene, or a combination thereof, the method comprising preparing an oral formulation comprising the nanoprecipitate of claim 1.

75. The method of claim 74, further comprising administering said formulation to a subject.

76-78. (canceled)
